(19) United States
(12) Patent Application Publication
(10) Pub. No.: US 2018/0189460 A1
(43) Pub. Date: Jul. 5, 2018

(54) LPA2 RECEPTOR-SPECIFIC BENZOIC ACID DERIVATIVES

(71) Applicant: University of Tennessee Research Foundation, Memphis, TN (US)

(72) Inventors: Renukadevi Patil, Germantown, TN (US); James Fells, Memphis, TN (US); Duane Miller, Germantown, TN (US); Gabor Tigyi, Memphis, TN (US)

(21) Appl. No.: 15/817,243

(22) Filed: Nov. 19, 2017

Related U.S. Application Data
(63) Continuation-in-part of application No. 14/222,473, filed on Mar. 21, 2014, now abandoned.
Application No. 14/222,473 is a continuation-in-part of application No. 14/011,739, filed on Aug. 27, 2013, now Pat. No. 9,056,835.
(60) Provisional application No. 61/693,731, filed on Aug. 27, 2012.

(51) Int. Cl. G06F 19/00

(52) U.S. Cl. CPC G06F 19/706

(57) ABSTRACT

Disclosed is a five-feature pharmacophore model of LPA₂ receptor specific agonists. Compounds may be identified as agonists of the LPA₂ receptor using the five-feature pharmacophore model.

### CROSS-REFERENCE TO RELATED APPLICATIONS

This application is a continuation-in-part of U.S. patent application Ser. No. 14/222,473, filed Mar. 21, 2014, now abandoned, which is a continuation-in-part of U.S. patent application Ser. No. 14/011,739, filed Aug. 27, 2013, which claims the benefit of priority of U.S. Provisional Patent Application No. 61/693,731, filed Aug. 27, 2012, the contents of which are incorporated herein by reference.

### FIELD OF THE INVENTION

The invention relates to a five-feature pharmacophore model provided for use in identifying LPA₂ specific receptor agonists.

### BACKGROUND OF THE INVENTION

The growth factor-like lysophospholipids lysophosphatidic acid (LPA) and sphingosine-1-phosphate (S1P) regulate many fundamental cellular responses, including cell survival, cell proliferation, cellular motility and migration. LPA has been shown to have profound activity in preventing apoptosis and rescuing cells from the progression of the apoptotic cascade. An LPA mimic, octadecenyl thiophosphate (OTP) (Durgam et al., Synthesis and pharmacological evaluation of second-generation phosphatidic acid derivatives as lysophosphatidic acid receptor ligands. Bioorg Med Chem Lett (2006) 16(3): 633-640), has demonstrated superior efficacy in vitro and in vivo, as compared to LPA, in rescuing cells and animals from radiation-induced apoptosis (Deng et al., The lysophosphatidic acid-type 2 receptor is required for protection against radiation-induced intestinal injury. Gastroenterology (2007) 132(5): 1834-1851).

The G protein-coupled lysophosphatidic acid 2 (LPA₂) receptor elicits prosurvival responses to prevent and rescue cells from apoptosis. LPA₂ stimulation provides protection from chemotherapeutic agent-induced apoptosis and radiation-induced apoptosis. Highly effective LPA₂-specific agonists may therefore have significant therapeutic value.

Development of LPA-based drug candidates has thus far been limited to the discovery of lipid-like ligands, primarily to address the hydrophobic environment of the S1P and LPA G protein-coupled receptor (GPCR) ligand binding pockets. Only a few LPA receptor ligands utilize nonlipid structural features, including Ki16425, an LPA_{1/2/3} antagonist (Ohta et al., Ki16425, a subtype-selective antagonist for EDG-family lysophosphatidic acid receptors. Mol Pharmacol (2003) 64(4): 994-1005), and the AM095-152 series of LPA₁-selective compounds (Swaney et al., Pharmacokinetic and pharmacodynamic characterization of an oral lysophosphatidic acid type 1 receptor-selective antagonist, J Pharmacol Exp Ther (2011) 336(3): 693-700). A major obstacle in developing LPA analogs is their high degree of hydrophobicity that makes these agents non-ideal drug candidates. Another complicating factor is the multiplicity of LPA GPCRs, which represents a significant challenge to the development of compounds specific to a single target such as LPA₂.

There are pharmacological advantages to the use of nonlipid molecules as pharmaceutical agents. Discovery and development of drug-like non-lipid compounds might produce even more efficacious molecules that can interact with LPA receptors in ways that will produce desirable cellular and systemic effects.

### SUMMARY OF THE INVENTION

In one aspect, the present invention relates to compounds of Formula I

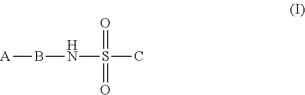

wherein A is

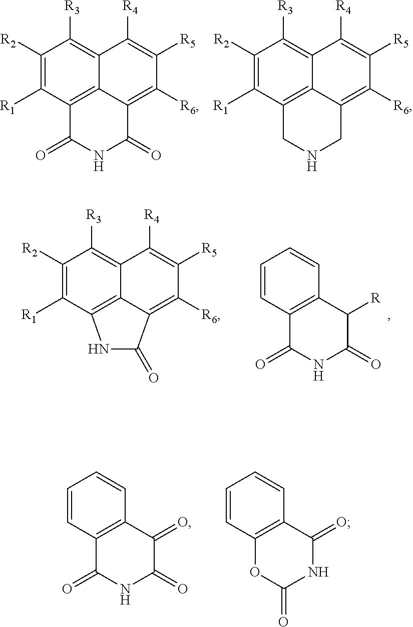

R is H or substituted or unsubstituted phenyl;
R₁, R₂, R₃, R₄, R₅, and R₆ are independently H, NO₂, Br, Cl, or OCH₃;
B is C₂ to C₈ alkyl or alkenyl; and

### C is

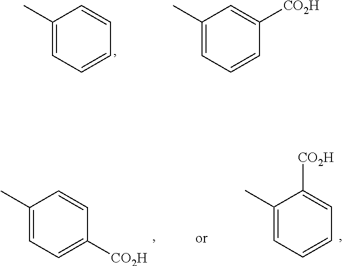

optionally substituted with F, Cl, Br, NO₂, NH₂, OCH₃, CH₃, CO₂H, or phenyl.

In further aspects, a pharmacophore of LPA₂ receptor is provided for use in identifying LPA₂ receptor specific agonists. Agonists thus identified are represented, but not limited to compounds of Formula I.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIGS. 1A, 1B, 1C and 1D are a series of 4 graphs illustrating receptor specificity of the prototype hit compound NSC12404 indicated by LPA GPCR-activated Ca²⁺-transients in cell lines expressing the individual LPA GPCR subtypes. The curves shown in these figures are representative of at least two experiments.

FIGS. 2A, 2B, 2C and 2D are a series of 4 graphs illustrating receptor specificity of the prototype hit compound NSC12404 indicated by LPA GPCR-activated Ca²⁺-transients in cell lines expressing the individual LPA GPCR subtypes. The curves shown in these figures are representative of at least two experiments.

FIGS. 3A, 3B, 3C and 3D are an illustration of a previously used pharmacophore for the LPA₂ GPCR. The three-dimensional three feature-pharmacophore generated (FIG. 3A) was based on the common structural features of docked LPA (FIG. 3B). GRI977143 (FIG. 3C), and NSC12404 (FIG. 3D). The pharmacophore properties are shown in red (anionic), blue (hydrogen bond acceptor), and green (hydrophobic interaction). The three agonists (ball and stick) used for pharmacophore development are shown with interactions with key amino acid residues (purple) within 4.5 Å of the previously validated ligand binding pocket.

FIGS. 4A and 4B are two illustrations of a five feature pharmacophore with compounds docked into the receptor and overlayed with the pharmacophore (A-B). FIGS. 4C and 4E show illustrations of the geometry of the LPA₂ receptor pharmacophore in FIG. 4A. FIGS. 4D and 4FC show illustrations of the geometry of the LPA₂ receptor pharmacophore in FIG. 4B. This pharmacophore is characterized by five features and defined by the following chemical properties: an anionic (red), two aromatic hydrophobic (orange), a hydrophobic (green), and an acceptor group (blue). Defining distances from each feature are measured in Å and shown in Table 3.

FIG. 5 illustrates the chemical structures of LPA18:1. Octadecenyl thiophosphate (OTP), and GRI977143.

FIG. 6 illustrates structural modifications proposed by the inventors for the development of a highly-effective and specific LPA₂ agonist.

FIG. 7 is a series of three schemes for synthesis of compounds of the invention.

FIGS. 8A and 8B are bar graphs illustrating inhibition of caspase-3/7 activation in LPA₂ DKO MEF cells (FIG. 8A) and in EV DKO MEF (FIG. 5B). LPA (1-3 μM), compound 5a (1-3 μM) and compound 7b (1-3 μM) were added to the cells 1 h before treatment with Adriamycin. Pretreatment with compounds 5a and 7b significantly reduced apoptosis in LPA₂ DKO MEF cells but not in EV DKO MEF cells (*p<0.05; **p<0.01; ***p<0.001).

FIGS. 9A and 9D are bar graphs illustrating the effect of LPA (1-3 μM) and compound 5a (3-10 μM) on DNA fragmentation in LPA₂ DKO MEF and in EV DKO MEF cells. Compound 5a at 3 μM concentration selectively protected LPA₂ transduced cells from Adriamycin induced DNA fragmentation (***p<0.001), 60 min pretreatment with 10 μM reduced DNA fragmentation by close to 50% percent in LPA₂ DKO MEF cells. There was no protection in EV DKO MEF cells.

FIGS. 10A and 10B are bar graphs illustrating inhibition of the initiator caspase 8 in LPA₂ DKO MEF cells and in empty vector DKO MEF cells LPA (3 μM), compound 5a (3-10 μM) were added to the cells 1 h before Adriamycin treatment.

FIGS. 11A and 11B are bar graphs illustrating inhibition of the initiator caspase 9 in LPA₂ DKO MEF cells and in empty vector DKO MET cells LPA (3 μM), compound 5a (3-10 μM) were added to the cells 1 h before Adriamycin treatment.

FIGS. 12A and 12B are bar graphs illustrating inhibition of executioner caspases 3 and 7 by LPA, compound 5a and 7b in LPA₂ DKO MEF cells (A) and in vector transduced cells (B). Protective compounds were added to the cells 1 h after irradiation with 15 Gy and caspase 3,7 activation was measured 4 h after irradiation. (***p<0.001 compared to irradiated vehicle.

FIGS. 13A and 13B are bar graphs illustrating inhibition of the initiator caspase 9 in LPA₂ DKO MEF cells (A) and in empty vector DKO MEF cells (B) (* p<0.05; ** p<0.01; *** p<0.001). Protective compounds LPA (1-3 μM), 5a and 7b (1-3 μM) were added to the cells 1 h after γ-irradiation with 15 Gy and DNA fragmentation was measured 4 hours after irradiation (**-p<0.001), compared to irradiated vehicle.

FIG. 14 is a mortality profile of C57BL/6 mice exposed to 15.68 Gy PBI-BM5 γ-irradiation. Notably, compounds 5a and 7a significantly reduced mortality (p<0.001), whereas compound 7b in this dosing and formulation was ineffective. The group sizes were 16-20 mice/group.

FIG. 15 is a graph illustrating the results of Fura-2AM Ca2+ Assay for Agonism of compounds RP-10-71 and RP-10-73. To determine the EC50 values of RP-10-71 and EP10-73 compared to LPA18:1 in Ca2+ mobilization, triplicate wells of Fura-2AM-loaded LPA2 DKO MEF cells were treated with 0.0003-0.1 μM LPA18:1 or 0.003-3 μM RP compounds in the presence of equimolar BSA in Krebs buffer. Fluorescence was read every 3.42 seconds for a total of 70 seconds at Ex/EMγ of 340/510 nm and 380/510 nm. Data (relative fluorescence) was then recorded as a mean fluorescence ratio value of the triplicates for each concentration. Graph Pad Prism version 5.0a was then used to fit a non-linear regression curve in a variable slope model (A) to determine the EC50, Emax, and curve fit (R²)(B). Numerical results are shown in Table 3 in the Examples.

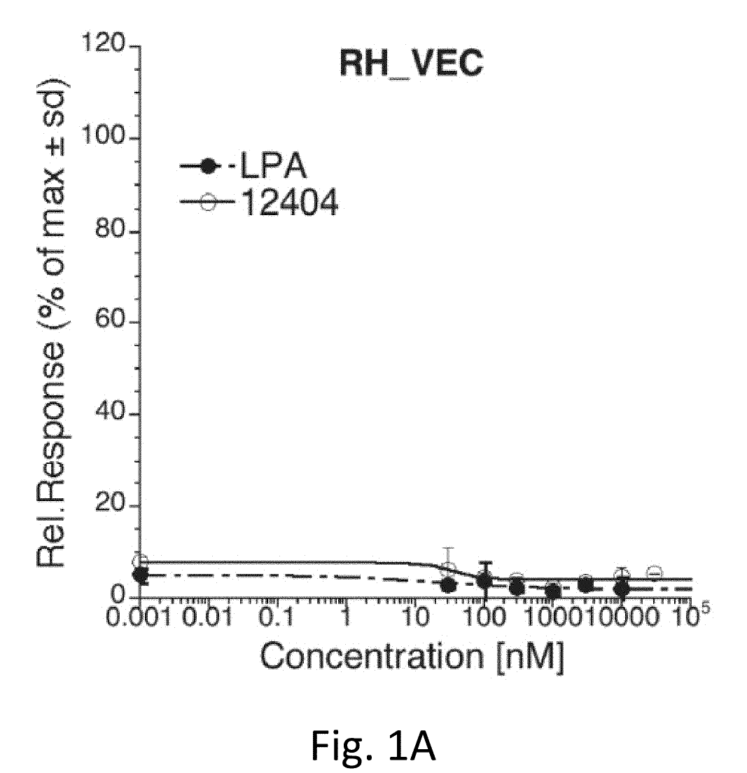

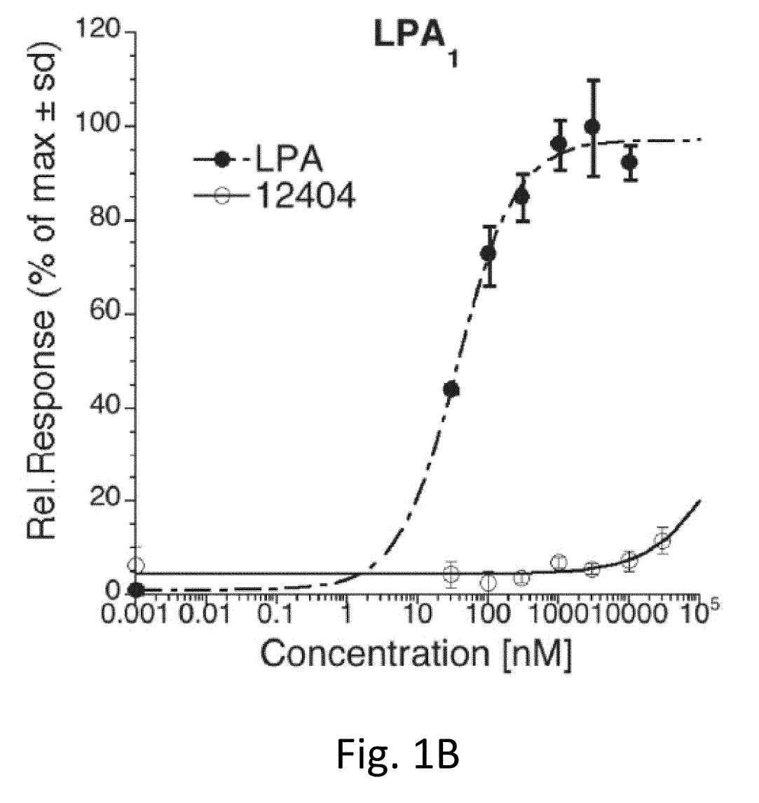

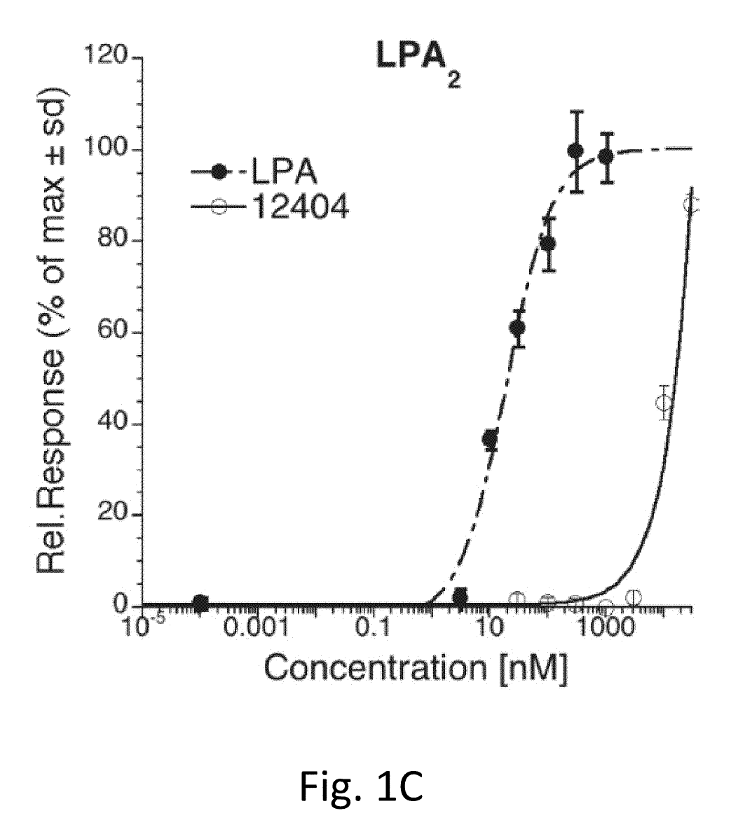

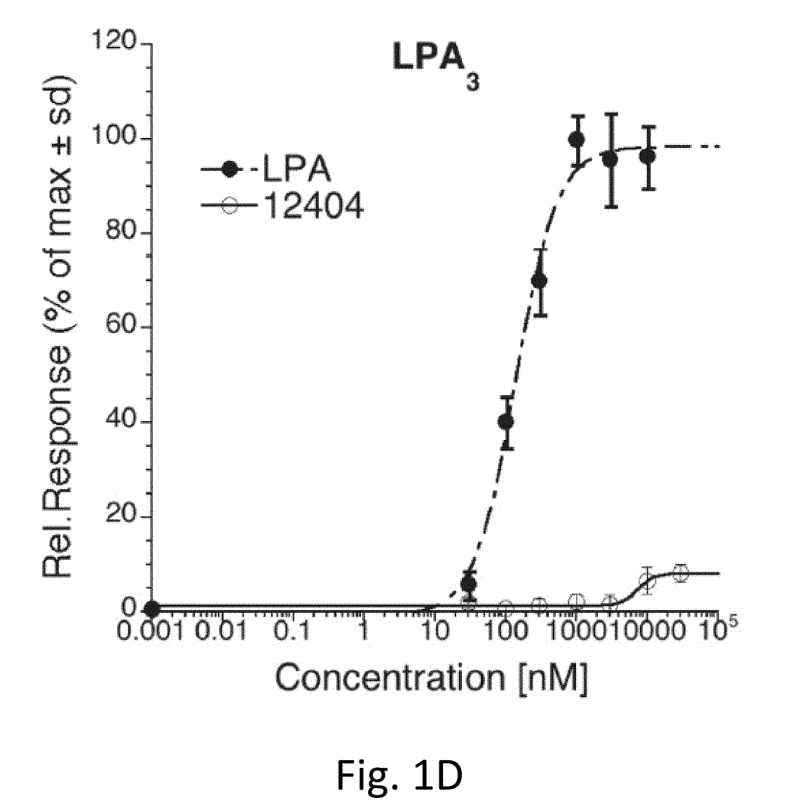

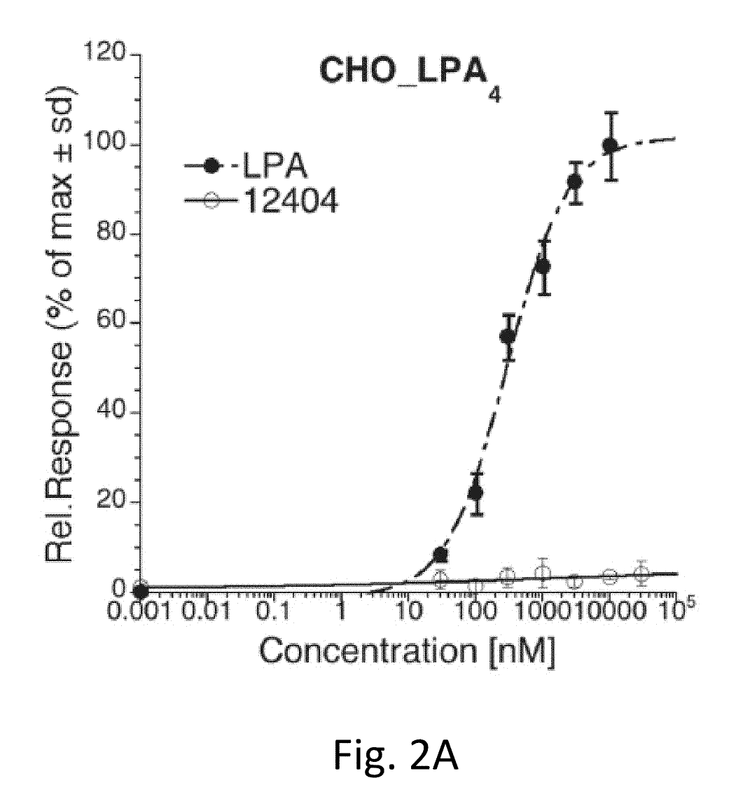

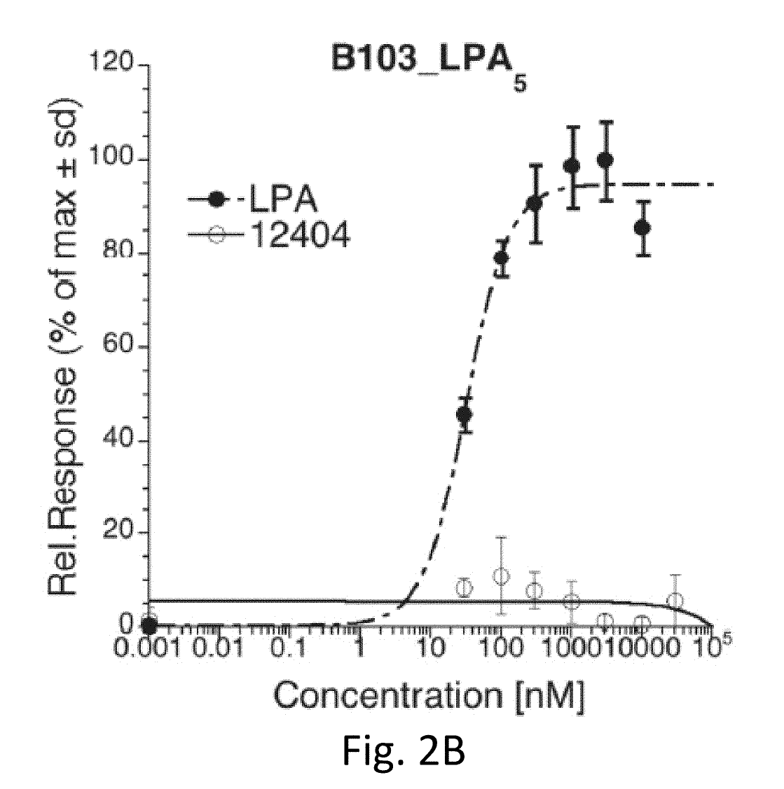

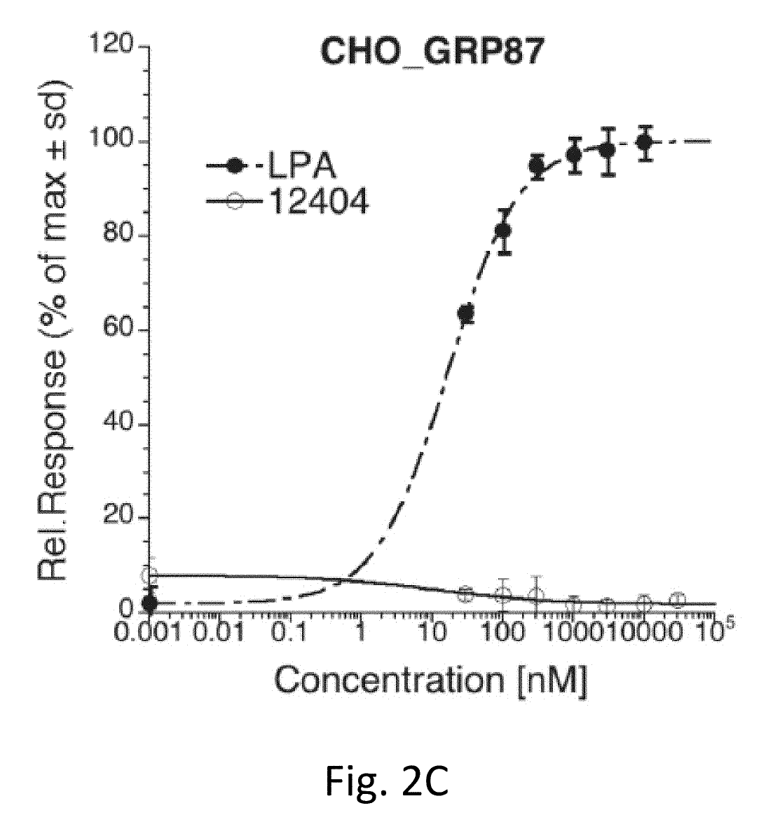

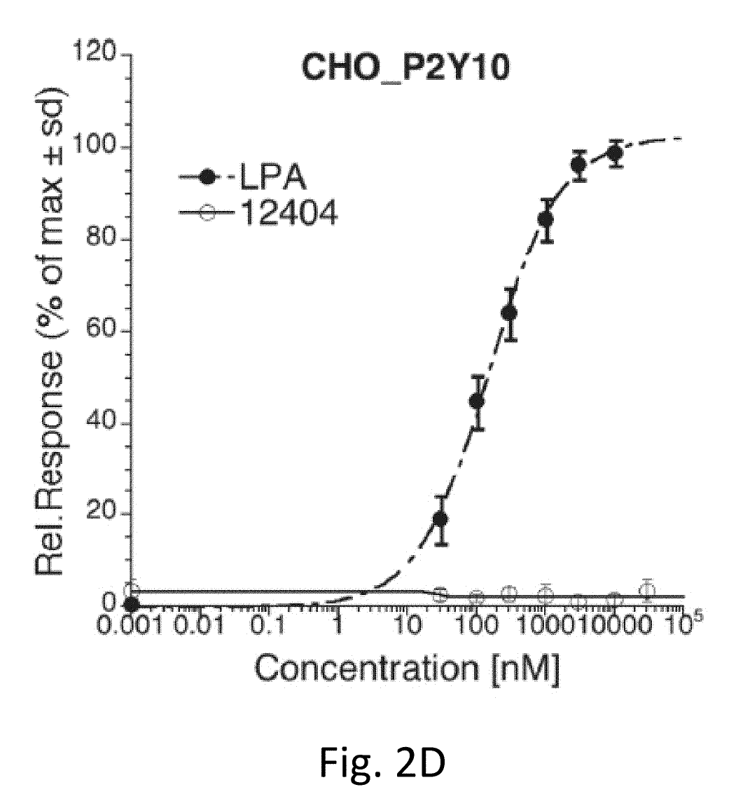

### DETAILED DESCRIPTION

The inventors have developed a pharmacophore model of LPA₂ receptor specific agonist. The inventors have used this model to develop benzoic acid derivatives that are useful as LPA₂ receptor-specific agonists that lack antagonist activity at all other known LPA receptor subtypes. Those compounds are effective for inhibiting apoptosis in damaged cells such as for example, cells damaged by irradiation and/or by exposure to chemotherapeutic agents such as those used for cancer chemotherapy. The compounds are also effective for promoting cell growth, and may be used either therapeutically or, for example, in tissue culture, to promote growth of target cells. LPA has been associated with increased cell survival in macrophages, Schwann cells, T lymphocytes, fibroblasts, endothelial cells, and osteoblastic cells. Current evidence suggests that this is an LPA₂-mediated effect. Therefore, compositions comprising compounds of the invention may also base therapeutic effect in a variety of conditions such as immune disorders, bone remodeling after injury, endothelial dysfunction, and congestive heart failure.

Compounds of the invention comprise compounds but are not limited to Formula I

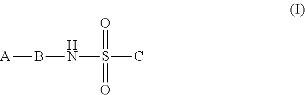

wherein A is

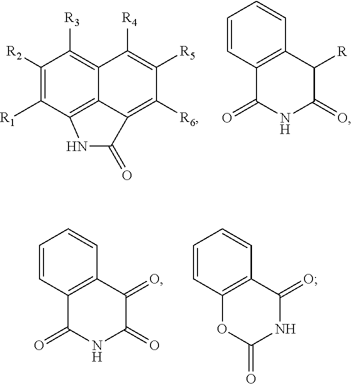

R is H or substituted or unsubstituted phenyl;
R₁, R₂, R₃, R₄, R₅, and R₆ are independently H, NO₂, Br, Cl, or OCH₃;
B is C₂ to C₈ alkyl or alkenyl; and

### C is

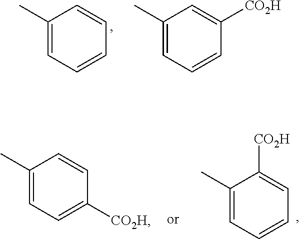

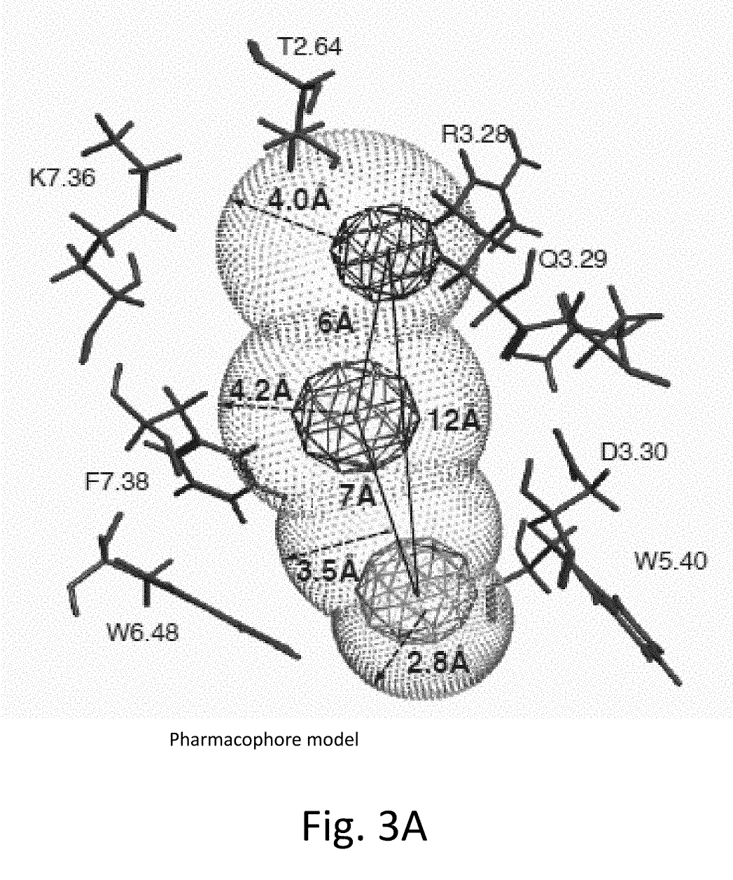

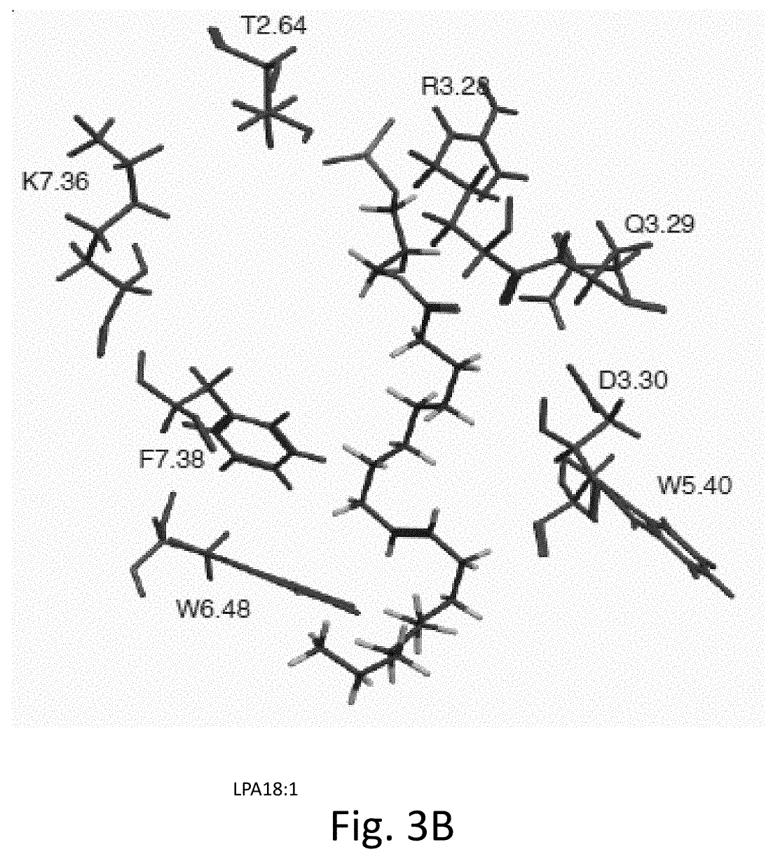

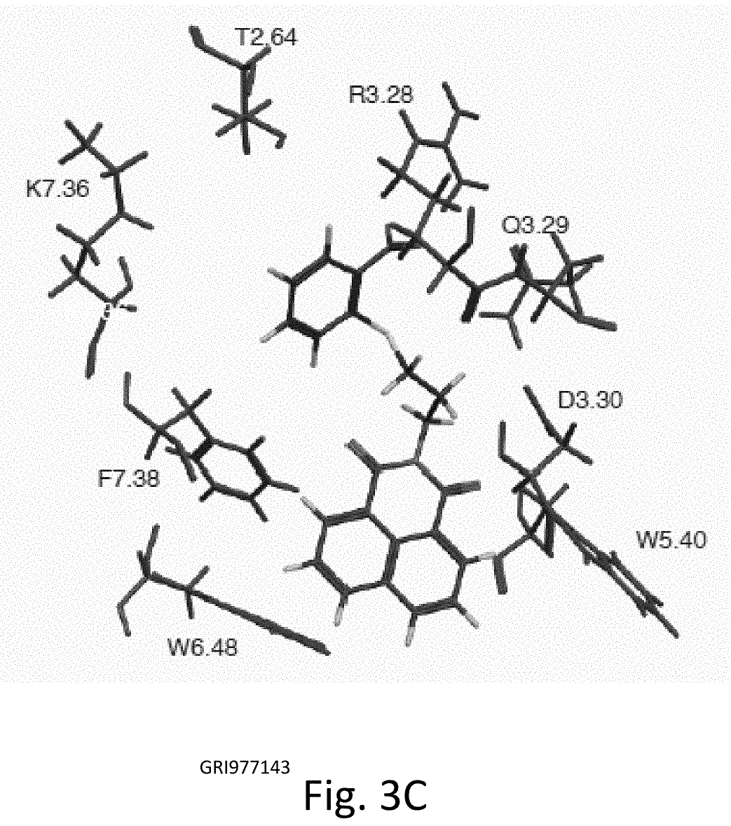

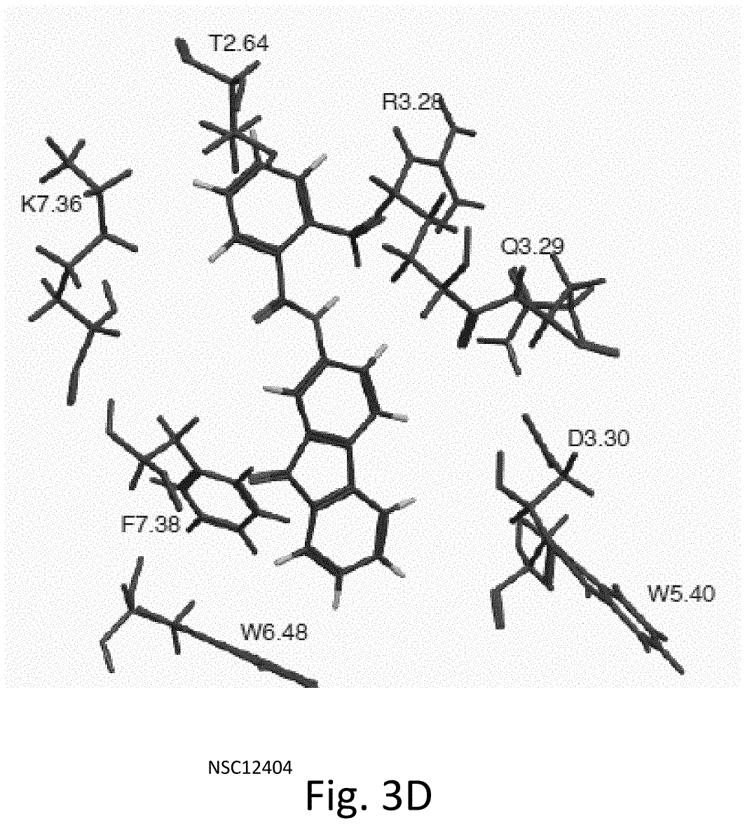

optionally substituted with F, Cl, Br, NO₂, NH₂, OCH₃, CH₃, CO₂H, or phenyl. Using the three feature pharmacophore model illustrated in FIG. 3 was used to conduct virtual screening for hits. They selected one of these hits (GRI977143 from the Genome Research Institute (GRI) chemical library), and characterized its cellular and signaling responses in several assay systems. Their results demonstrated that the compound GRI977143 is a specific agonist of LPA₂ and does not activate any other known or putative LPA GPCR. The inventors have also shown that GRI977143 is effective in a similar manner to LPA in preventing programmed cell death, although in Ca²⁺-mobilization and caspase 3 and 7 inhibition assays it has a higher EC₅₀ than LPA. GRI977143 lacked LPA₂ specificity exemplified by its antagonist activity at the LPA3 receptor. See Table 1, GRI977143 inhibited activation of caspases 3, 7, 8, and 9, B-cell lymphoma 2 (Bcl-2)-associated X protein (Bax) translocation, and poly (ADP-ribose) polymerase 1 (PARP-1) cleavage, leading to reduced DNA Segmentation following activation of the extrinsic or intrinsic apoptotic signaling cascades. They also demonstrated that GRI977143 robustly activates the extracellular signal regulated kinases 1/2 (ERK1/2) survival pathway and leads to the assembly of a macromolecular signalosome consisting of LPA₂, thyroid receptor interacting protein 6 (TRIP6), and Na⁺—H⁺ exchange regulatory factor 2 (NHERF2), which has been shown to be required for the pro-survival signaling elicited via this receptor subtype, further confirming its LPA₂ receptor subtype specificity. The invention therefore provides a method for inhibiting apoptosis and increasing cell survival after chemotherapeutic and/or radiation damage to cells and tissues. The method comprises administering to a human and or animal subject a therapeutically effective dose of GRI977143 to increase cell survival after the human and or animal subject has been exposed to chemotherapeutic agents and/or ionizing radiation.

Similarity searches were performed separately using each fingerprint to quantitate similarity. Hits meeting the 80% similarity threshold from each search were ranked based on the Tanimoto coefficient measure of similarity to a target-molecule NSC12404, and the top 75 unique hits from each fingerprint search were selected for further analysis. The 225 compounds selected for further analysis were clustered based on Tanimoto coefficients calculated using Molecular ACCess System-key fingerprints (MACCS keys) and evaluated using the diversity subset function implemented in MOE. This selected a diverse subset of 27 compounds for biological evaluation by choosing the middle compounds in each cluster. These 27 compounds were tested in mobilization assays at a concentration of 10 μM using stable cell lines individually expressing LPA₂ and also in vector-transfected control cells. Hits activating LPA₂ were further tested using cells expressing the other established and putative LPA GPCRs. Experimental testing of the selected compounds identified the three new selective LPA₂ agonists: GRI977143, H2L5547924. and H2L5828102, H2L5547924, H2L5828102 and GRI977143 activated only LPA₂ and failed to activate any of the other established and putative LPA GPCRs when applied at levels up to 10 μM. These compounds have also been tested at 10 μM for the inhibition of the Ca²⁺ response elicited by ˜EC₇₅ concentration of LPA 18:1 at those receptors that the compound failed to activate when applied at 10 μM. The inventors found that at this high concentration NSC12404 and GRI977143 inhibited LPA₃ but none of the other receptors they tested were either activated or inhibited by these two compounds. H2L5547924 not only activated LPA₂ but partially inhibited LPA₁LPA₄, GPR87, and P2Y10. H2L5528102 not only was a specific agonist of LPA₂ but also fully inhibited LPA₃ and partially inhibited LPA₁, GPR87 and P2Y10. Results are shown in Table 1. They arbitrarily selected GRI977143 for further synthetic optimization in order to generate an LPA₂ specific agonist without any agonist or antagonist LPA receptor activity at other receptor subtypes other than LPA₂.

TABLE 1

| | | LPA₁ | | LPA₂ | | LPA₃ | | LPA₄ | | LPA₅ | | GPR87 | | P2Y10 | |
|---|---|---|---|---|---|---|---|---|---|---|---|---|---|---|---|
| | | Iₘₐₓ | EC₅₀ | Iₘₐₓ | EC₅₀ | Iₘₐₓ | EC₅₀ | Iₘₐₓ | EC₅₀ | Iₘₐₓ | EC₅₀ | Iₘₐₓ | EC₅₀ | Iₘₐₓ | EC₅₀ |
| Compound | LogP | (%) | (μM) | (%) | (μM) | (%) | (μM) | (%) | (μM) | (%) | (μM) | (%) | (μM) | (%) | (μM) |
| LPA 18:1 | 6.12 | | 0.13 | | 0.030 | | 0.080 | | 0.25 | | 0.015 | | 0.049 | | 0.029 |
| OTP | 7.72 | | 0.651 | | 0.336 | | 0.297 | | 2.0 | | 0.003 | | 3.0 | ND | ND |
| NSC 12404 | 3.25 | NE | NE | — | 9.5 | 61 | — | NE | NE | NE | NE | NE | NE | NE | NE |
| GRI 977143 | 3.88 | NE | NE | — | 3.3 | 55 | — | NE | NE | NE | NE | NE | NE | NE | NE |
| H2L 5547924 | 4.36 | 21 | — | — | 2.8 | 66 | — | 51 | — | NE | NE | 31 | — | 34 | — |
| H2L 5828102 | 2.78 | 29 | — | — | 3.3 | 100 | — | NE | NE | NE | NE | 21 | — | 39 | — |
| | | | | | | (K = 1.5) | | | | | | | | | |

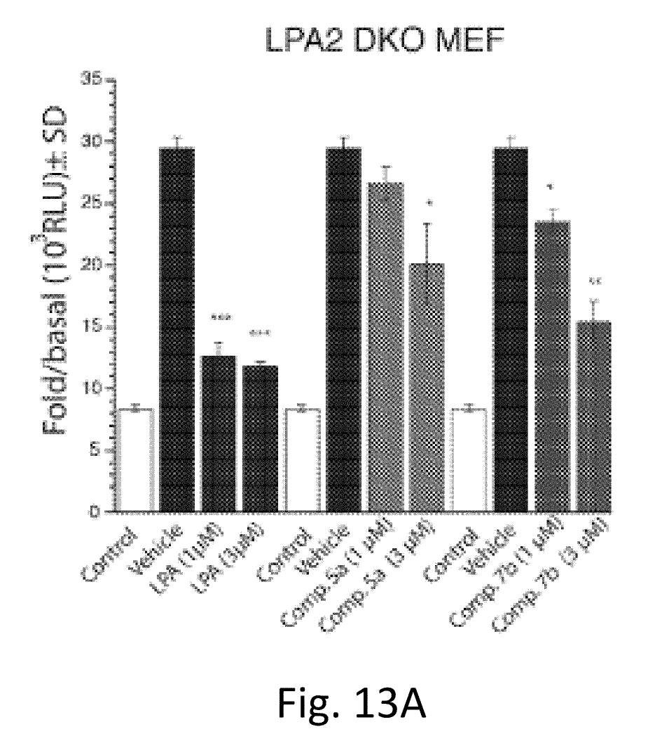

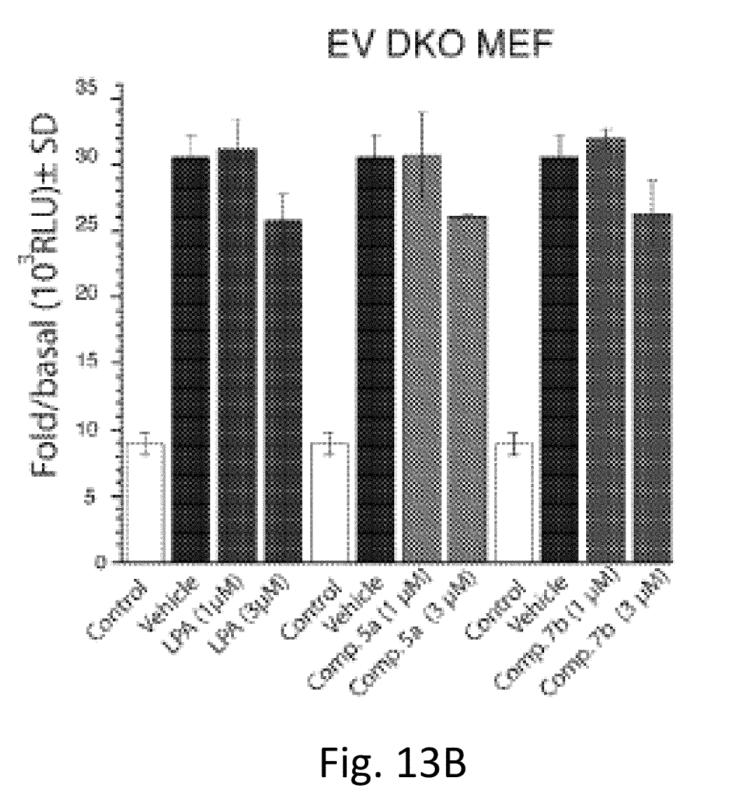

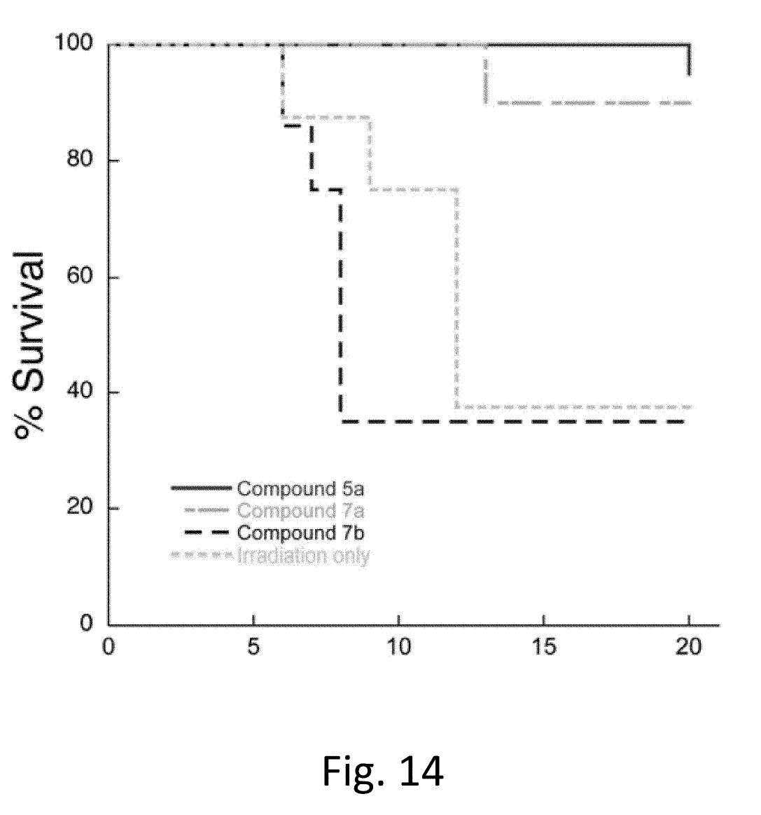

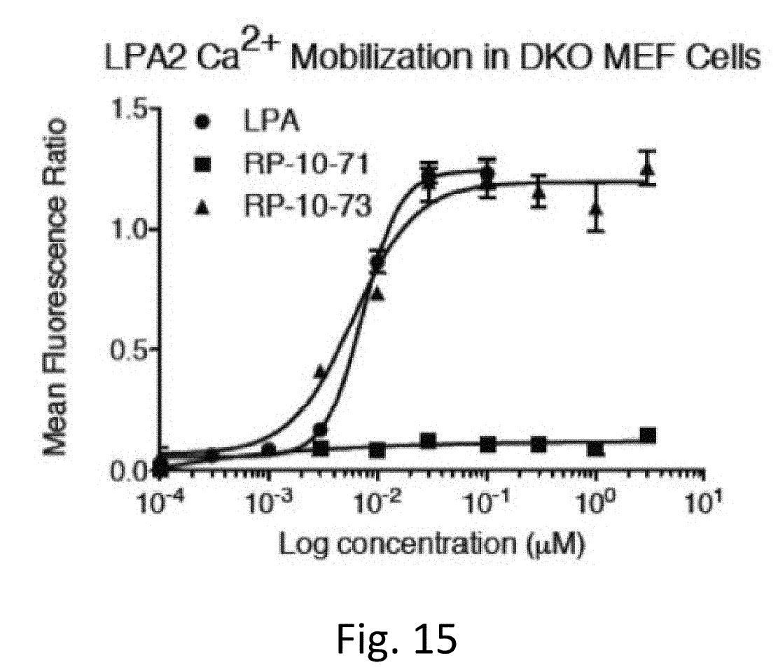

The inventors then synthesized novel sulfamoyl benzoic acid derivatives, compounds 5a-c, 7a-c, 9 and 10 as show in Schemes 1, 2, and 3, respectively, of FIG. 13, Compounds 3a-c were prepared by modification of a previously-reported procedure. Briefly, formation of compounds 3a-c was accomplished by the reaction of benzo[de]isoquinoline-1,3-dione (1) and corresponding dibromoalkanes (2a-c) in presence of K₂CO₃/acetone under reflux conditions in quantitative yield. The compound 3a-c was reacted with 2-sulfamoylbenzoic acid ethyl ester 4 in K₂CO₃/DMF and furnished compound 5a-c in moderate yield (Scheme 1). The reaction of 2-(4-bromobutyl)benzo[de]isoquinoline-1,3-dione (3b) with substituted benzo[d]isothiazol-3(2H)-one-1,1-dioxides 6a-c and 8 in the presence of K₂CO₃ and DMF produced compound 7a-c and 9 respectively (Schemes 2 and 3). Compound 9 was treated with aqueous 1N NaOH in EtOH gave the final compound 10 (Scheme 3).

The newly-synthesized compounds were tested for their ability to induce Ca²⁺ transients in RH7777 cells stably expressing the LPA₂ receptor. The effect of these new compounds (5a-c, 7a-c, 9 and 10) on the activity of LPA₂ receptor is shown in Table 2. These compounds lacked agonist or antagonist activity at all other subtypes other than LPA₂. A refined pharmacophore model comprised of five features was developed based on the pharmacological properties of the new compounds. This five feature pharmacophore model defines specific LPA₂ agonist features.

TABLE 2
Regulation of LPA₂ Receptor Activity by New Compounds

| | | | EC₅₀ (μM); | EC₅₀ (μM) |
|---|---|---|---|---|
| | | | Emax (%) | Emax (%) |
| Compound | Carbon linker | Log P | (RH7777) | (DKO MEF) |
| GRI-977143 | 3 | 3.88 | 3.3; 64 | ND |
| 5a | 3 | 2.7 | 2.2; 100 | ND |
| 5b | 4 | 3.16 | 0.5; 100 | 0.5; 100 |
| 5c | 5 | 3.62 | 1.2; 100 | ND |
| 7a | 4 | 3.12 | >10 | >10 |
| 7b | 4 | 4.05 | 1; 100 | 0.4; 100 |
| 7c | 4 | 3.29 | >10 | ND |
| 9 | 4 | 2.74 | 3.6; 75 | ND |
| 10 | 4 | 2.52 | NE | NE |

All reagents and solvents were purchased from Aldrich, Alfa-Aesar, Chemgenx Product List, Matrix Scientific, and TCI-America Fine Chemicals, and used without further purification. The reactions were performed under an inert atmosphere of argon. ¹H-NMR spectra were recorded on a Bruker ARX 400 and Varian 500 spectrometer at 400 MHz and 500 MHz, respectively and were referenced to internal (CH₃)₄Si. Chemical shift values were reported as parts per million (δ), coupling constants (J) are given in Hz, and splitting patterns are designated as follows: bs, broad singlet; d, doublet; t, triplet; q, quartet; m, multiplet. Mass spectra were collected on a Bruker ESQUIRE electrospray/ion trap instrument in the positive and negative modes. Routine thin-layer chromatography (TLC) was performed on silica gel plates (Analtech, Inc., 250 microns). Flash chromatography was conducted on silica gel (Merck, grade 60, 230-400 mesh).

2-(bromoalkyl)benzo[de]isoquinoline-1,3-dione (3a-c) (GP-1)

To a solution of benzo[de]isoquinoline-1,3-dione 1 (1 equiv) in dry acetone were added anhydrous K3CO3 (3 equiv) and corresponding dibromoalkane (2a-c) (3 equiv). The reaction mixture was refluxed for 22 h, cooled to room temperature and filtered. The solvent was evaporated under reduced pressure and the crude product was purified by flash column chromatography to afford the title compound.

2-[3-(1,3-dioxo-1H,3H-benzo[de]isoquinolin-2-yl)-alkylsulfamoyl]benzoic acid (5a-c) (GP-2)

To a stirred mixture of 2-sulfamoylbenzoic acid ethyl ester 4 (1 equiv) and anhydrous K₂CO₃ (5 equiv) in DMF was added 2-(bromoalkyl)benzo[de]isoquinoline-1,3-dione (3a-c) (3 equiv). The reaction mixture was gently refluxed for overnight, cooled to room temperature and poured into the crushed ice. The resulted solution was acidified with concentrated HCl and extracted with chloroform. The organic layer was washed with water, dried over anhydrous Na₂SO₄ and concentrated tinder vacuum to get the crude product. The crude residue was purified by flash column chromatography to obtain the desired product.

2-(N-(4-(1,3-dioxo-1H-benzo[de]isoquinolin-2(3H)-yl)butyl)sulfamoyl)-4-substituted benzoic acid (7a-c) (GP-3)

To a stirred mixture of 6-substituted benzo[d]isothiazol-3(2H)-one 1,1-dioxide 6a-c (1 equiv) and anhydrous K₂CO₃ (5 equiv) in DMF was added 2-(4-bromobutyl)-1H-benzo[de]isoquinoline 1,3(2H)-dione (3b) (3 equiv). The reaction mixture was gently refluxed for overnight, cooled to room temperature and poured into the crushed ice. The resulted solution was acidified with con. HCl and extracted with chloroform. The organic layer was washed with water, dried over anhydrous Na₂SO₄ and concentrated under vacuum to get the crude product. The Crude product was purified by flash column chromatography to afford the title product.

2-(3-Bromopropyl)benzo[de]isoquinoline-1,3-dione (3a)

This compound was prepared according to GP-1 using benzo[de]isoquinoline-1,3-dione (1) and 1,2 dibromopropane (2a) The crude product was purified by flash column chromatography using EtOAc-hexane to provide 3a. ¹H NMR (500 MHz, CDCl₃) δ 8.62 (d, J=7.0 Hz 2H), 8.23 (d, J=8.0 Hz 2H), 7.77 (t, J=7.5 Hz, 2H), 4.34 (t, J=7.5, 2H), 3.51 (t, J=7.0 Hz, 2H), 2.37-2.32 (m, 2H), MS (ES+) m/z 340 (M+Na)³⁰ .

2-(4-Bromobutyl)benzo[de]isoquinoline-1,3-dione (3b)

This compound was prepared according to GP-1 using benzo[de]isoquinoline-1,3-dione (1) and 1,2 dibromobutane (2b) The crude residue was purified by flash column chromatography using EtOAc-hexane to get 3b. ¹H NMR (500 MHz, CDCl₃) δ 8.61 (d, J=7.5 Hz 2H), 8.22 (d, J=8.5 Hz, 2H), 7.77 (t, J=7.5 Hz, 2H), 4.34 (t, J=7.5, 2H), 3.49 (t, J=7.0 Hz, 2H), 2.03-1.91 (m, 4H). MS (ES+) m/z 354 (M+Na)⁺.

### 2-(5-Bromopentyl)benzo[de]isoquinoline-1,3dione (3c)

This compound was prepared according to GP-1 using benzo[de]isoquinoline-1,3-dione (1) and 1,2 dibromopentane (2c) The crude product was purified by flash column chromatography using EtOAc-hexane to give 3c. ¹H NMR (500 MHz, CDCl₃) δ 8.63 (d, J=7.5 Hz 2H), 8.24 (d, J=8.0 Hz, 2H), 7.7S (t, J=7.5 Hz, 2H), 4.22 (t, J=7.0, 2H), 3.45 (t, J=7.0 Hz, 2H), 2.01-1.94 (m, 2H), 1.84-1.78 (m, 2H), 1.64-1.57 (m, 2H), MS (ES+) m/z 368 (M+Na)⁻.

2-[3-(1,3-Dioxo-1H,3H-benzo[de]isoquinolin-2-yl)propylsulfamoyl]benzoic acid (5a)

The compound was prepared according to GP-2 using 2-sulfamoyl benzoic acid ethyl ester 4 and compound 3a. The crude product was purified by flash column chromatography using MeOH—CHCl₃ to obtain 5a. ¹H NMR (500 MHz, DMSO-d₆) δ 9.43 (bs, 2H), 8.49-8.46 (m, 4H), 7.87 (t, J=8.0 Hz, 2H), 7.68 (d, J=7.5 Hz 1H), 7.64 (d, J=8.0 Hz 1H), 7.49 (t, J=7.5 Hz, 1H), 7.33 (t, J=7.5 Hz, 1H), 4.02 (t, J=7.5, 2H), 2.76 (q, J=7.0 Hz, 2H), 1.90-1.60 (m, 2H). MS (ES−) m/z 437 (M-H)⁻.

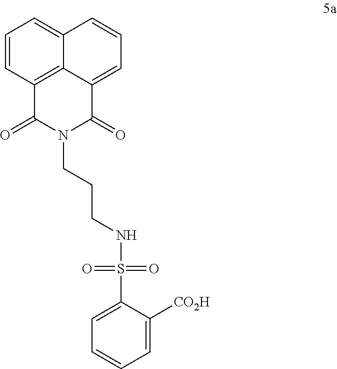 [SMILES: O=C(O)c1ccccc1S(=O)(=O)NCCCN1C(=O)c2cccc3cccc(c23)C1=O]

2-[4-(1,3-Dioxo-1H,3H-benzo[de]isoquinolin-2-yl)butylsulfamoyl]benzoic acid (5b)

The compound was prepared according to GP-2 using 2-sulfamoylbenzoic acid ethyl ester 4 and compound 3b. The crude product was purified by flash column chromatography using MeOH—CHCl₃ to obtain 5b. ¹H NMR (500 MHz, DMSO-d_{δ}) δ 9.27 (bs, 2H), 8.49-8.45 (m, 4H), 7.97 (t, J=8.0 Hz, 2H), 7.69 (d, J=8.0 Hz 1H), 7.63 (d, J=8.0 Hz 1H), 7.44 (t, J=7.5 Hz, 1H), 7.32 (t, J=7.5 Hz, 1H), 3.99 (t, J=7.0, 2H), 2.71 (q, J=7.0 Hz, 2H), 1.04-1.56 (m, 2H), 1.46-1.38 (m, 2H) MS (ES−) m/z 451 (M-H)⁻.

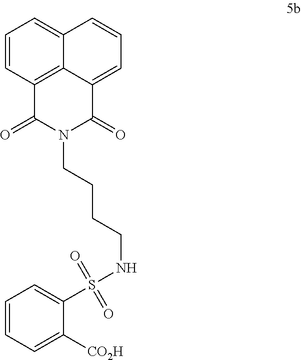 [SMILES: O=C(O)c1ccccc1S(=O)(=O)NCCCCN1C(=O)c2cccc3cccc(c23)C1=O]

2-[4-(1,3-Dioxo-1H,3H-benzo[de]isoquinolin-2-yl pentylsulfamoyl]benzoic acid (5c)

The compound was prepared according to GP-2 using 2-sulfamoylbenzoic acid ethyl ester 4 and compound 3c. The crude residue was purified by flash column chromatography using MeOH—CHCl₃ to obtain 5c. ¹H NMR (400 MHz, DMSO-d_{δ}) δ 9.17 (bs, 2H), 8.50-8.45 (m, 4H), 7.89-7.85 (m, 2H), 7.72 (d, J=10.0 Hz 1H), 7.66 (d, J=10.0 Hz 1H), 7.51 (t, J=10.0 Hz 1H), 7.39 (t, J=10.0 Hz, 1H), 3.97 (t, J=9.5, 2H), 2.68 (q, J=8.0 Hz, 2H), 1.58-1.50 (m, 2H), 1.44-1.38 (m, 2H), 1.33-1.26 (m, 2H). MS (ES−) m/z 465 (M-H)⁻.

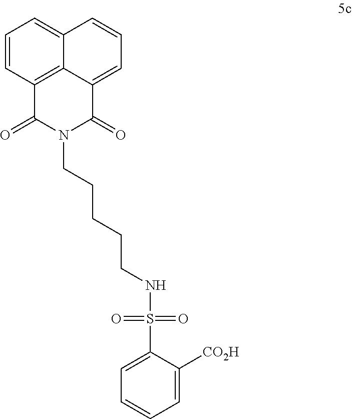 [SMILES: O=C(O)c1ccccc1S(=O)(=O)NCCCCCN1C(=O)c2cccc3cccc(c23)C1=O]

2-(N-(4-(1,3-dioxo-1H-benzo[de]isoquinolin-2(3H)-yl)butyl)sulfamoyl)-4-nitrobenzoic acid (7a)

The compound was prepared according to GP-3 using 6-nitrobenzo[d]isothiazol-3(2H)-one 1,1-dioxide 6a. The crude residue was purified by flash column chromatography using MeOH—CHCl₃ to obtain 7a. ¹H NMR (400 MHz, DMSO-D_{δ}) δ 9.47 (t, J=5.6 Hz, 1H), 8.51-8.45 (m, 4H), 7.86-7.81 (m, 4H, 2H), 7.62 (d, J=8.4 Hz 1H), 7.26 (s, 1H), 7.01 (q, J=2.8 Hz, 1H), 3.95 (t, J=6.8 Hz, 2H), 2.83-2.72 (m, 2H), 1.62-1.65 (m, 2H), 1.50-1.38 (m, 2H). MS (ES−) m/z 496 (M-H)⁻.

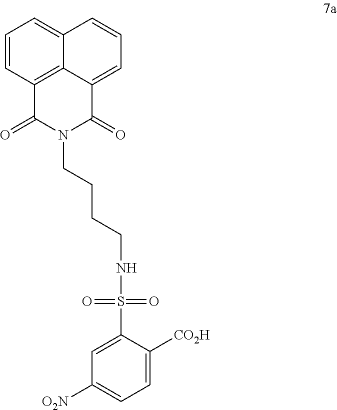 [SMILES: O=C(O)c1ccc([N+](=O)[O-])cc1S(=O)(=O)NCCCCN1C(=O)c2cccc3cccc(c23)C1=O]

4-bromo-2-(N-(4-(1,3-dioxo-1H-benzo[de]isoquinolin-2(3H)-yl)butyl)sulfamoyl) benzoic acid (7b)

The compound was prepared according to GP-3 using 6-bromo[d]isothiazol-3(2H)-one 1,1-dioxide 6b. The crude residue was purified by flash column chromatography using MeOH—CHCl₃ to obtain 7b. ¹H NMR (400 MHz, DMSO-d_{δ}) δ 9.13 (t, J=5.2 Hz, 1H), 8.52-8.44 (m, 4H), 7.88 (t, J=8.0 Hz, 2H), 7.70 (d, J=7.6 Hz 1H), 7.60 (d, J=7.6 Hz 1H), 7.47-7.41 (m, 1H), 4.08 (t, J=7.6 Hz, 2H), 2.78-2.67 (m, 2H), 1.64-1.57 (m, 2H), 1.48-1.39 (m, 2H). MS (ES−) m/z 529 (M-H)⁻.

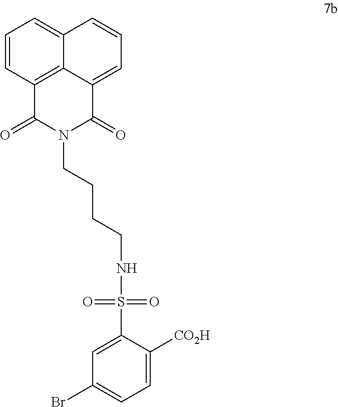 [SMILES: O=C(O)c1ccc(Br)cc1S(=O)(=O)NCCCCN1C(=O)c2cccc3cccc(c23)C1=O]

2-(N-(4-(1,3-dioxo-1H-benzo[de]isoquinolin-2(3H)-yl)butyl)sulfamoyl)-4-methoxybenzoic acid (7c)

The compound was prepared according to GP-3 using 6-methoxybenzo[d]isothiazol-3(2H)-one 1,1-dioxide 6c. The crude residue was purified by flash column chromatography using MeOH—CHCl₃ to obtain 7c. ¹H NMR (400 MHz, DMSO-d_{δ}) δ 9.31 (t, J=5.2 Hz, 1H), 8.56-8.41 (m, 4H), 7.88 (t, J=8.0 Hz, 2H), 7.61 (d, J=8.0 Hz 1H), 7.37 (d, J=4.0 Hz, 1H), 6.95 (dd, J=2.8, 2.8 Hz, 1H), 4.08 (t, J=8.0 Hz, 2H), 3.79 (s, 3H), 3.24 (q, J=6.8 Hz, 2H), 1.77-1.69 (m, 2H), 1.60-1.52 (m, 2H). MS (ES−) m/z 481 (M-H)⁻.

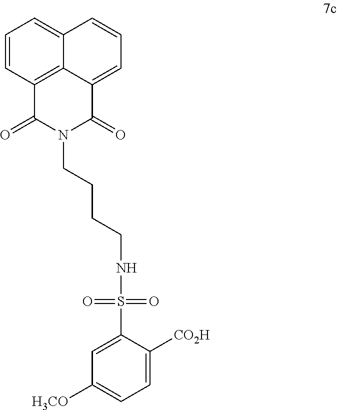 [SMILES: COc1ccc(C(=O)O)c(S(=O)(=O)NCCCCN2C(=O)c3cccc4cccc(c34)C2=O)c1]

2-(4-(1,3-dioxo-1H-benzo[de]isoquinolin-2(3H)-yl)butyl)-3-oxo-2,3-dihydrobenzo[d]isothiazole-6-carboxylic acid 1,1-dioxide (9)

To a stirred mixture of 3-oxo-2,3-dihydrobenzo[d]isothiazole-6-carboxylic acid 1,1-dioxide (8) (1 mmol) and anhydrous K₂CO₃ (5 mmol) in DMF was added 2-(4-bromobutyl)-1H-benzo[de]isoquinoline-1,3(2H)-dione (3b) (3 mmol). The inaction mixture was gently refluxed for overnight, cooled to room temperature and poured into the crushed ice. The resulted solution was acidified with con. HCl and extracted with ethylacetate. The organic layer was washed with water, dried over anhydrous Na₂SO₄ and concentrated under vacuum to get the crude product. The Crude residue was purified by flash column chromatography using MeOH—CHCl₃ (2:8) to obtain the desired product. ¹H NMR (400 MHz, DMSO-d_{δ}) δ 8.54-8.34 (m, 6H), 7.91-7.77 (m, 3H), 4.41-4.37 (m, 2H), 4.14-4.08 (m, 2H), 1.89-1.71 (m, 4H). MS (ES−) m/z 477 (M-H)⁻.

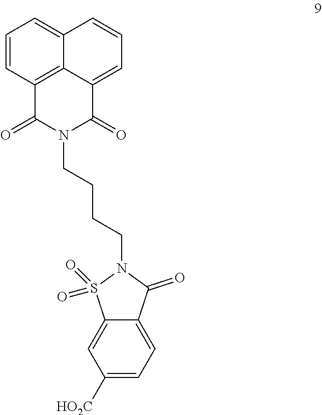 [SMILES: O=C(O)c1ccc2c(c1)S(=O)(=O)N(CCCCN1C(=O)c3cccc4cccc(c34)C1=O)C2=O]

2-(N-(4-(1,3-dioxo-1H-benzo[de]isoquinolin-2(3H)-yl)butyl)sulfamoyl)terephthalic acid (10)

A suspension of 9 (50 mg) and aqueous 1N NaOH (3 ml) was stirred at room temperature for 10 min. To this suspension, ethanol (2 mL) was added until the solution became clear. Stirring was continued for 2 h until starting material was disappeared. The solution was poured into ice-water and acidified with 37% HCl to a pH of 1. The resulted mass was extracted with ethyl acetate, the organic layer was washed with water, dried over anhydrous Na₂SO₄ and concentrated under vacuum to get the crude product. The crude residue was recrystallized using EtOAc-Hexane-DCM to afford the title compound. ¹H NMR (400 MHz, DMSO-d_{δ}) δ 13.5 (bs, 1H), 9.30 (bs, 1H), 8.58-8.35 (m, 4H), 8.05 (d, J=8.0 Hz, 1H), 7.99-7.86 (m, 2H), 7.65-6.52 (m, 2H), 4.01-3.97 (m, 2H), 3.50-3.40 (m, 2H), 1.52-1.40 (m, 4H). MS (ES−) m/z 495 (M-H)⁻.

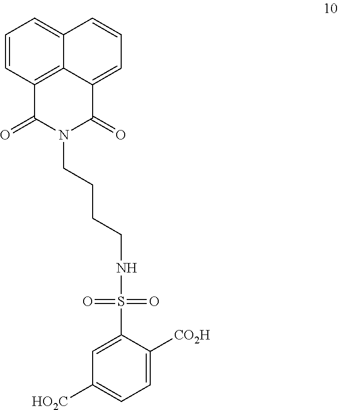 [SMILES: O=C(O)c1ccc(C(=O)O)c(S(=O)(=O)NCCCCN2C(=O)c3cccc4cccc(c34)C2=O)c1]

The invention may be further described by means of the fallowing non-limiting examples.

### EXAMPLES

Lysophosphatidic acid (18:1) was purchased from Vanti Polar Lipids (Alabaster, Ala.). OTP was synthesized and provided by RxBio, Inc. (Johnson City, Tenn.) as described (Durgam et al., 2006). The test compounds used in the present study were obtained from the following vendors: Genome Research Institute (GRI) GRI977143 from the University of Cincinnati Drug Discovery Center (UC-DDC; Cincinnati, Ohio); Hit2Lead (www.hit2lead.com) H2L5547924, and H2L5828102, from Chem Bridge (San Diego, Calif.); and NSC12404 from the National Cancer Institute Developmental Therapeutics Program Open Chemical Repository. Ten mM stock solutions of GRI977143, H2L5547924, H2L5828102, and MSC12404 were prepared in dimethyl sulfoxide (DMSO). One millimolar stocks of LPA and OTP as an equimolar complex of charcoal-stripped, fatty acid-free bovine serum albumin (BSA) (Sigma-Aldrich1 St. Louis, Mo.) were prepared just before use in phosphate-buffered saline (PBS). A stock solution of 3.45 mM Adriamycin was prepared in distilled water.

### Computational Docking

Compounds were flexibly docked into the activated LPA2 receptor homology model reported by Sardar et al. (Sardar et al., Molecular basis for lysophosphatidic acid receptor antagonist selectivity. Biochim Biophys Acta (2002) 1582(1-3): 309-317) using Autodock Vina (Trott and Olson, AutoDock Vina: improving the speed and accuracy of docking with a new scoring function, efficient optimization, and multithreading. J. Comput. Chem. (2010) 31(2): 455-461). The compounds and receptor homology model were both energy optimized with the Merck Molecular Force Field 94 (MMFF94) in the Molecular Operating Environment software (MOE, 2010.10 version) prior to docking. Docking simulations were performed using a docking box with dimensions of 65×63×50 Å and a search space of 20 binding modes, and an exhaustive search parameter was set at 5. The best docking pose was chosen based on the lowest energy conformation. Finally, the best pose was further refined using the MMFF94 in MOE.

### Ligand-based Similarity Search

Similarity: searching of NSC12404 was performed using the UC-DDC library database (drugdiscovery.uc.edu). The Tanimoto similarity indices for the reference compounds were calculated using ECFC6, FCFP4, and FCFP6 fingerprints in Pipeline Pilot software (Accelerys, Inc., San Diego. Calif.). The UC-DCC library was screened using Pipeline Pilot fingerprints to identify additional LPA₂ ligands. A similarity threshold was set at 80%. Among the 225 returned hits, compounds with similarity >80% were selected by visual inspection, carefully considering the similarity and how closely the structures reflected the reference compound. A total of 27 compounds was selected for evaluation using LPA receptor-activated Ca²⁺-mobilization assays.

### Residue Nomenclature

Amino acids in the transmembrane (TM) domains were assigned index positions to facilitate comparison between GPCRs with different numbers of amino acids, as described by Ballesteros and Weinstein (Ballesteros and Weinstein, Integrated methods for the construction of three dimensional models and computational probing of structure-function relations in G-protein coupled receptors. Methods Neurosci (1995) 25: 366-425). An index position is in the format X.YY., where X denotes the TM domain in which the residue appears, and YY indicates the position of that residue relative to the most highly conserved residue in that TM domain, which is arbitrarily assigned position 50.

### LPA Receptor-mediate Ca²⁺ Mobilization Assay

Stable cell lines expressing the individual LPA₁, LPA₂, LPA₃, LPA₄, and LPA₅ established receptor subtypes, as well as putative LPA receptors GPR87 and P2Y10, or appropriate empty vector-transfected controls have been previously generated and described (Murakami et al., Identification of the orphan GPCR, P2Y(10) receptor as the sphingosine-1-phosphate and lysophosphatidic acid receptor. Biochem Biophys Res Commun (2008) 371(4): 707-712: Tabata et al. The orphan GPCR GPR87 was deorphanized and shown to be a lysophosphatidic acid receptor. Biochem Biophys Res Commun (2007) 363(3): 861-866; Williams et al., Unique ligand selectivity of the GPR92/LPA5 lysophosphatidate receptor indicates role in human platelet actuation. J Biol Chem (2009) 284(25): 17304-17319). Assays for ligand-activated mobilization of intracellular Ca²⁺ were performed using a Flex Station 2 robotic fluorescent plate reader (Molecular Devices; Sunnyvale, Calif.) as previously described (Durgam et al., Synthesis and pharmacological evaluation of second-generation phosphatic acid derivatives as lysophosphatidic acid receptor ligands. Bioorg Med Chem Lett (2006) 16(3): 633-640). The appropriate concentrations of the test compounds were either used alone (for agonist testing) or mixed with the respective ˜EC₇₅ concentration of LPA 18:1 for the LPA receptor being tested (antagonist screen). The cells were loaded with Fura-2-acetoxymethyl esther (Fura-2/AM) in Krebs buffer containing 0.01% pluronic acid for 30 min and rinsed with Krebs buffer before measuring Ca²⁺ mobilization. The ratio of peak emissions at 510 nm after 2 min of ligand addition was determined for escalation wavelengths of 340 nm/380 nm. All samples were run in quadruplicate. The inhibition elicited by 10 μM test compound on the EC₇₅ concentration of LPA 18:1 for a given receptor (I_{10 μM}) was interpolated from the dose-response curves. The half maximally effective concentration (EC₅₀), and inhibitors constant (Kᵢ) values were calculated by fitting a sigmoid function to dose-response data points using KaleidaGraph software (version 4.1. Synergy Software; Dubai, United Arab Emirates).

### Cell Proliferation Assay

For determination of the effect of the LPA receptor ligands on cell growth, vector- and LPA₂-transduced MEF cells (2×10⁴) were plated in each well of a 24-well plate in full growth medium. Cells were counted the next day and the medium was replaced with medium containing 1.5% (V/V) FBS supplemented with or without 1 μM LPA, 1 μM OTP, or 10 μM GRI977143. Media containing LPA, OTP, and GRI977143 were refreshed every 24 h. The growth rate was measured by counting the number of cells in triplicate using the Z1 Coulter Particle Counter (Beckman Coulter; Hileah, Fla.) as a function of time.

### Induction of Apoptosis by Adriamycin or Serum Withdrawal

Experiments were performed on vector- and LPA₂-transduced MEF cells. To measure caspase 3, 7, 8, or 9 activity and DNA fragmentation, cells were plated in 48-well plates (2×10⁴ cells/well). To detect PARP-1 cleavage and Bax translocation, 1.5×10⁶ cells were plated in 10-cm dishes and cultured overnight in full growth medium. The next morning, the growth medium was replaced by serum-starvation medium and cells were pretreated for 1 h with LPA (1-10 μM), OTP (1-10 μM), GR1977143 (1-10 μM), or vehicle. Caspase activity, DNA fragmentation, PARP-1 cleavage, and Bax translocation were measured 5 h after incubation with 1.7 μM Adriamycin or 24 h after serum withdrawal.

Induction of Apoptosis by Tumor Necrosis Factor α(TNF-α) in IEC-6 Cells

Confluent serum-starved IEC-6 cells were treated with or without TNF-α (10 ng/ml/cycloheximide (CHX) (20 μg/ml) in the presence of OTP (10 μM), GRI977143 (10 μM), or LPA (1 ρM) for 3 h. Cells were washed twice with PBS and the quantitative DNA fragmentation assay was carried out as described previously (Valentine et al., (S)-FTY720-vinylphosphonate, an analogue of the immunosuppressive agent FTY720, is a pan-antagonist of sphingosine 1-phosphate GPCR signaling and inhibits autotaxin activity. Cell Signal (2010) 22(10): 1543-1553).

### Caspase Activity Assay

Caspase-Glow® 3/7, Caspase-Glow® 8 and Caspase-Glow® 9 reagents were purchased from Promega (Madison, Wis.) and used according to the manufacturer's instructions. Briefly, cells were lysed by adding 50 μl of lysis reagent per well, followed by shaking for 30 min at room temperature. Two bundled μl lysate were transferred to a 96-well white-wall plate, and luminescence was measured using a BioTek® Winooski, Ver.) plate reader.

### DNA Fragmentation ELISA

Apoptotically-challenged cells were washed twice with PBS, and a quantitative DNA fragmentation assay was carried out using a Cell Death Detection ELISA PLUS kit (Roche Diagnostics, Penzberg, Germany) and normalized to protein concentration using the BCA Protein Assay Kit (Thermo Fisher Scientific, Inc.; Rockford, Ill.) as described previously (Valentine et al., 2010). Aliquots of nuclei-free cell lysate were placed in streptavidin-coated wells and incubated with anti-histone-biotin antibody and anti-DNA peroxidase-conjugated antibody for 2 h at room temperature. After the incubation, the sample was removed, and the wells were washed and incubated with 100 μl 2,2′-azino-di[3-ethylbenzthiazolin-sulfonate substrate at room temperature before the absorbance was read at 405 nm. Results were expressed as absorbance at 405 nm/min/mg protein as detailed in our previous report (Ray et al., Mdm2 imbibition induces apoptosis in p53 deficient human colon cancer cells by activating p73- and E2F1-mediated expression of PUMA and Siva-1. Apoptosis (2011) 16(1): 35-44).

### MM1 Hepatoma Cell Invasion of Endothelial Monolayer

HUVEC (1.3×10⁵ cells at passages 5 to 7) were seeded into each well of a 12-well plate pre-coated with 0.2% gelatin (Sigma-Aldrich). Cells were grown for two days until a confluent monolayer was formed. MM1 cells were prelabeled with 2 μg/mL calcein AM (Life Technologies; Grand Island, N.Y.) for 2 h and rinsed twice, and 5×10⁴ cells per well were seeded, over the HUVEC monolayer. Tumor-monolayer cell invasion was carried out for 20 h in MCDB-131 complete media containing 1% FBS with or without the addition of 1 μM LPA or 1-10 μM GRI977143. Non-invaded tumor-cells were removed by repeatedly rinsing the monolayer with PBS (containing Ca²⁺ and Mg²⁺), followed by fixation with 10% buffered formalin. Tumor cells that penetrated the monolayer were photographed using a NIKON TiU inverted microscope with phase-contrast and fluorescence illumination. The fluorescent and phase-contrast images were overlaid using Elements BR software (Nikon, version 3.1x). A total of five non-overlapping fields was imaged per well, and the number of invaded MM1 cells (displaying a flattened morphology underneath the monolayer) was counted.

### Immunoblot Analysis

To detect ligand-induced ERK1/2 activation, vector- and LPA-transfected MEF cells were serum starved 3 h before exposure to 1 μM LPA, 1 μM OTP, 10 μM GRI977143, or vehicle for 10 min. For ERK1/2 activation and PARP-1 cleavage measurements, cells were harvested in 1× Laemmli sample buffer and separated using 12% Laemmli SDS-polyacrylamide gels. To assess Bax translocation, cell lysates were separated into cytosolic, mitochondrial, and nuclear fractions using the Cell Fractionation Kit-Standard (MitoSciences; Eugene, Ore.). Cytosolic fractions were then concentrated by precipitation with 75% trichloroacetic acid, and the pellets were dissolved in 50 mM non-neutralized Tris pH 10 buffer and 6× Laemmli buffer. Samples were boiled for 5 min and loaded onto 12% SDS-polyacrylamide gels. Western blotting was carried out as previously described (Valentine et al., 2010). Primary antibodies against pERK1/2, PARP-1, Bax (Cell Signaling Technology; Beverly, Mass.), actin (Sigma-Aldrich), and anti-rabbit-horseradish peroxidase secondary antibodies (Promega) were used according to the instructions of the manufacturer.

Detection of Ligand-induced Macromolecular Complex Formation with LPA₂

LPA₂ forms a ternary complex with TRIP6 and NHERF2. This complex is assembled via multiple protein-protein interactions that include: binding of NHERF2 to the C-terminal PSD95/Dlg/ZO-1 domain (PDZ)-binding motif of LPA₂, the binding of TRIP6 to the Zinc-finger-like CxxC motif of LPA₂, and binding of NHERF2 to the PDZ-binding motif of TRIP6. To examine ligand-induced macromolecular complex formation, HEK293T cells were transfected with FLAG-LPA2 and enhanced green fluorescent protein (EGFP)-NHERF2, and the cells were exposed to 10 μM GRI977143 for 10 min as described in detail in our previous publication (E et al., The LPA₂ receptor-mediated supramolecular complex formation regulates its antiapoptotic effect. J Biol Chem (2009) 284: 14558-14571). The complex was pulled down using anti-FLAG M2-monoclonal antibody-conjugated agarose beads (Sigma-Aldrich) and processed For western blotting using anti-EGFP (gift from Dr. A. P. Naren; UTHSC, TN), anti-FLAG (Sigma-Aldrich), and anti-TRIP6 (Bethyl Laboratories; Montgomery, Tex.) antibodies.

### Statistical Analysis

Data are expressed as mean±SD or SEM for samples run in triplicates. Each experiment was repeated at least two times. Student's t-test was used for comparison between the control and treatment groups. A p value ≤0.05 was considered significant.

The LPA₂ computational model docked with LPA 18:1 suggests 13 residues that comprise the ligand binding pocket. Computational docking of the four hits indicates that these LPA₂ ligands interact with some additional residues unique to a specific agonist in addition to the 13 common residues. The model of GRI977143 docked to the LPA2 structure is shown in FIG. 3. The docked structure shows that GRI977143 docks in the vicinity of the key residues R3.28, Q3.29, K7.36, and W4.64, which, the inventors have previously shown are required for ligand activation of LPA₂. In addition, the model predicted an interaction with W5.40 that was unique to this ligand.

A structure-based pharmacophore was developed using the docking function of the MOE software (Molecular Operating Environment, MOE software (2002), Chemical Computing Group, Montreal). Compound NSC12404 and LPA were docked into a homology model of LPA₂ receptor. In the pharmacophore model, the inventors identified three feature sites based on the interactions between the agonists and the protein. The inventors defined the key residues as those within 4.5 Å of our LPA₂ agonists. The pharmacophore features and the corresponding amino acid residues involved in ligand interactions are shown in FIG. 3A. This pharmacophore model has three features: a hydrophobic feature (green), a hydrogen bond acceptor (blue), and an anionic (red) feature. The four volume spheres in the pharmacophore with radii in the 2.8-4.2 Å range delineate the regions ideal for different types of chemical interactions with the ligand in the binding pocket. The distances between chemical features along with the radii of the four volume spheres are shown in FIG. 3A.

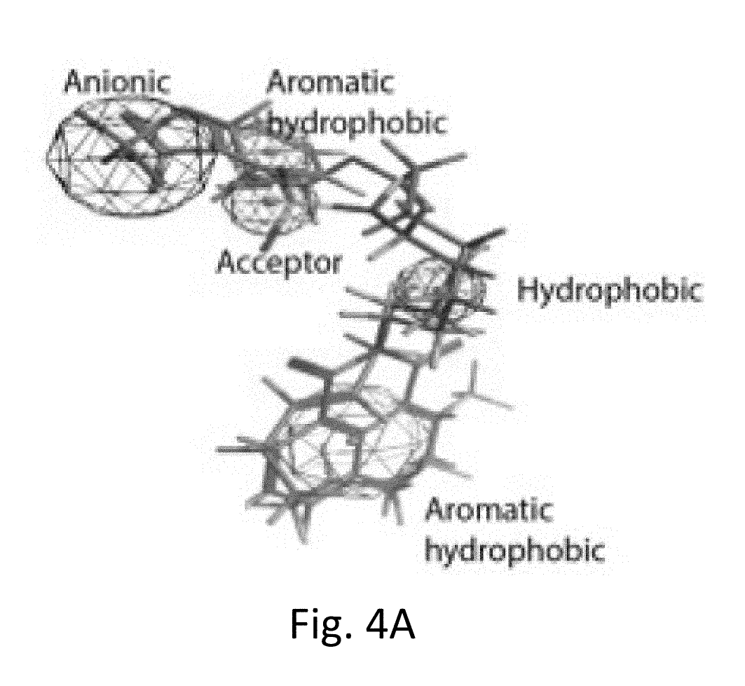

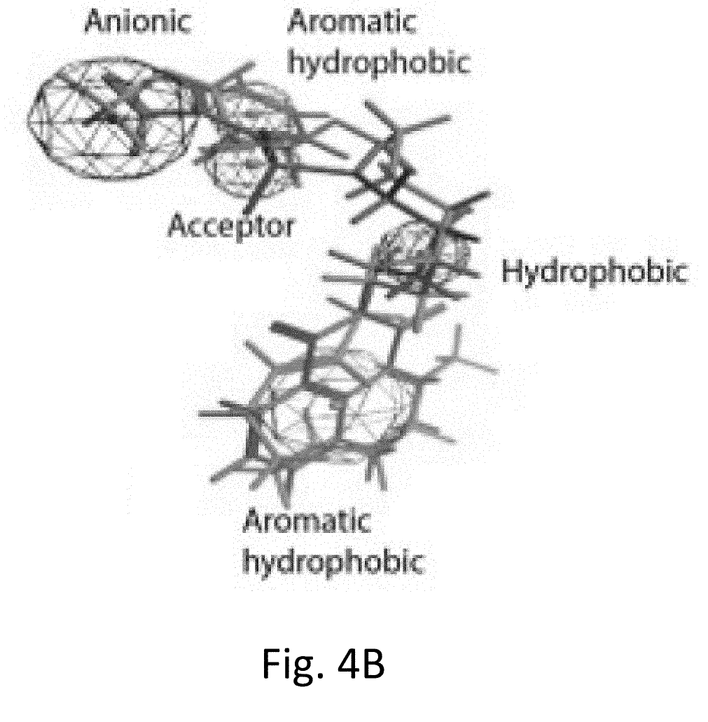

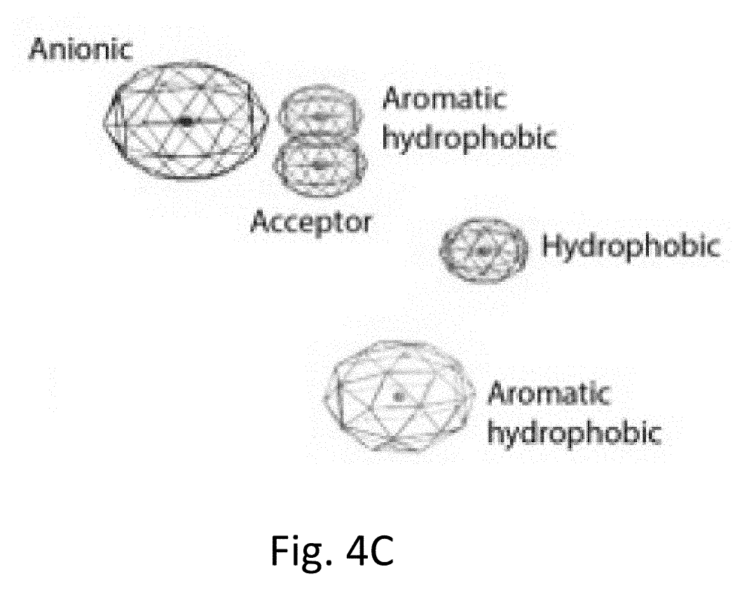

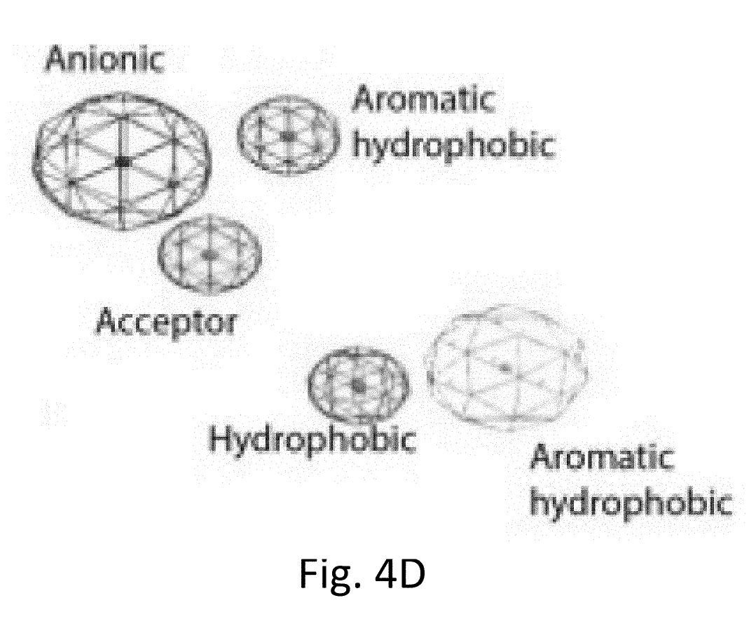

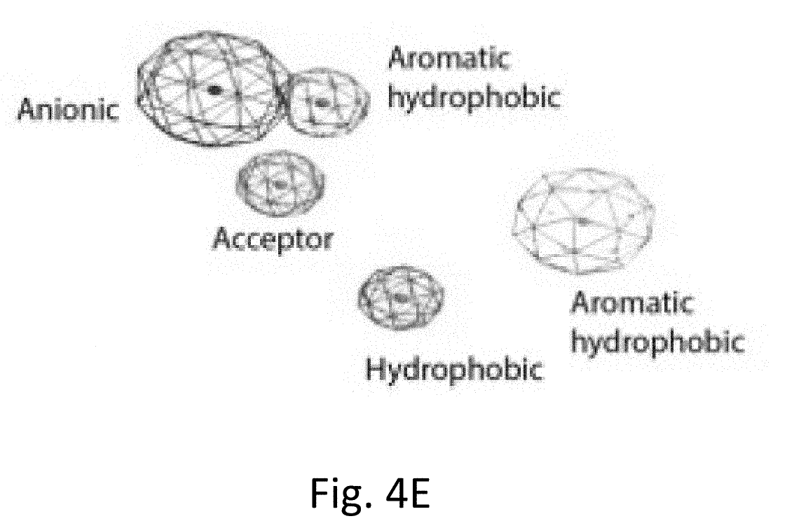

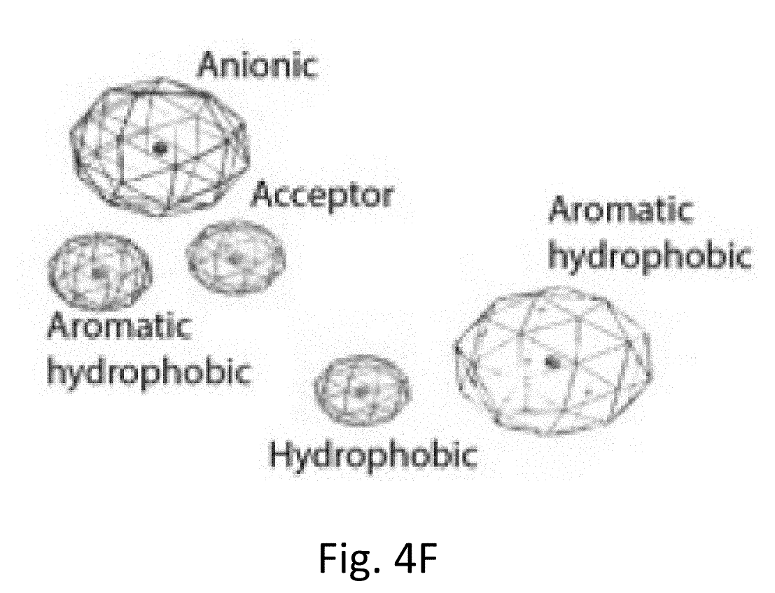

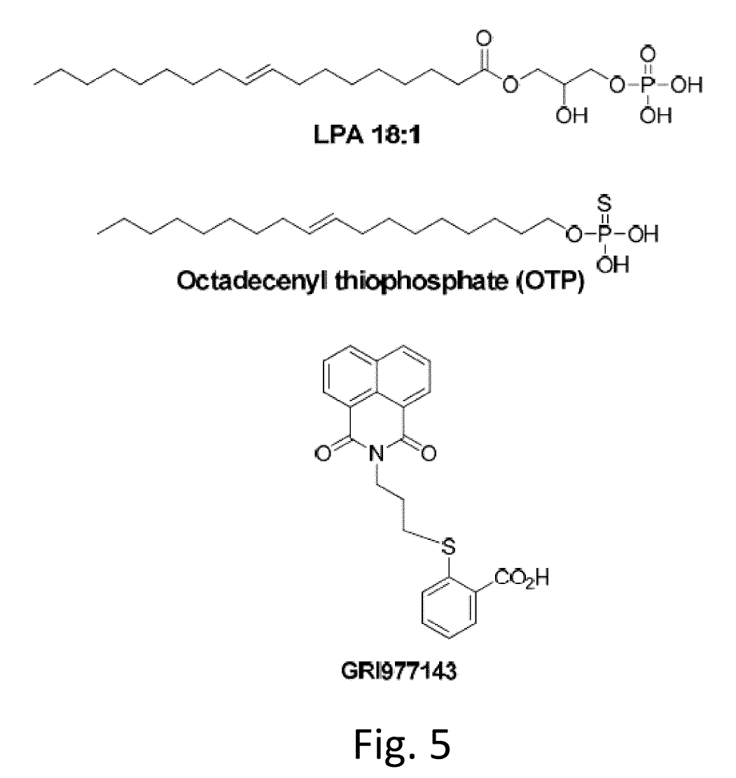

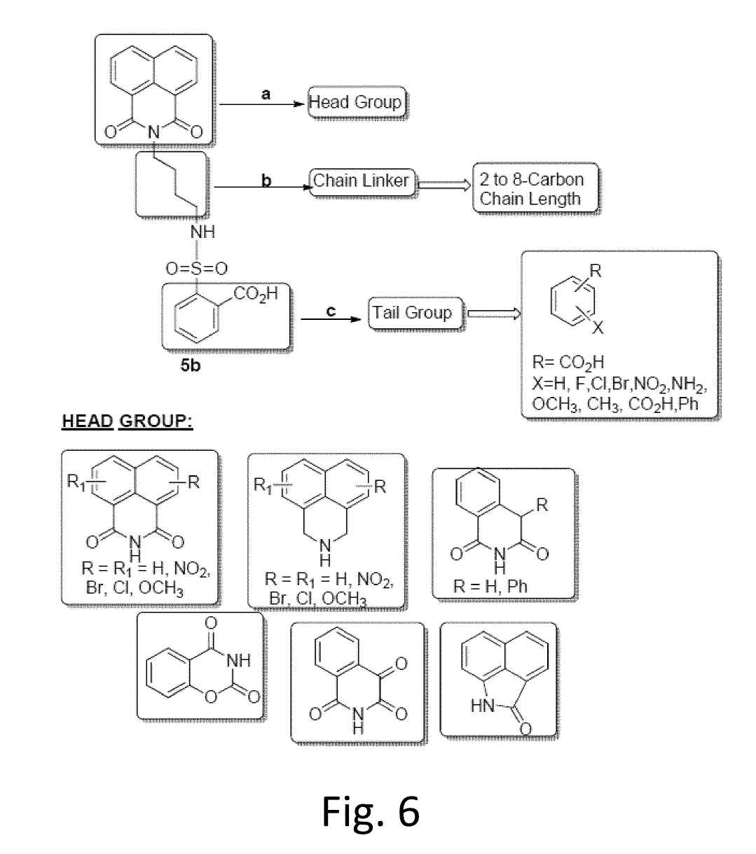

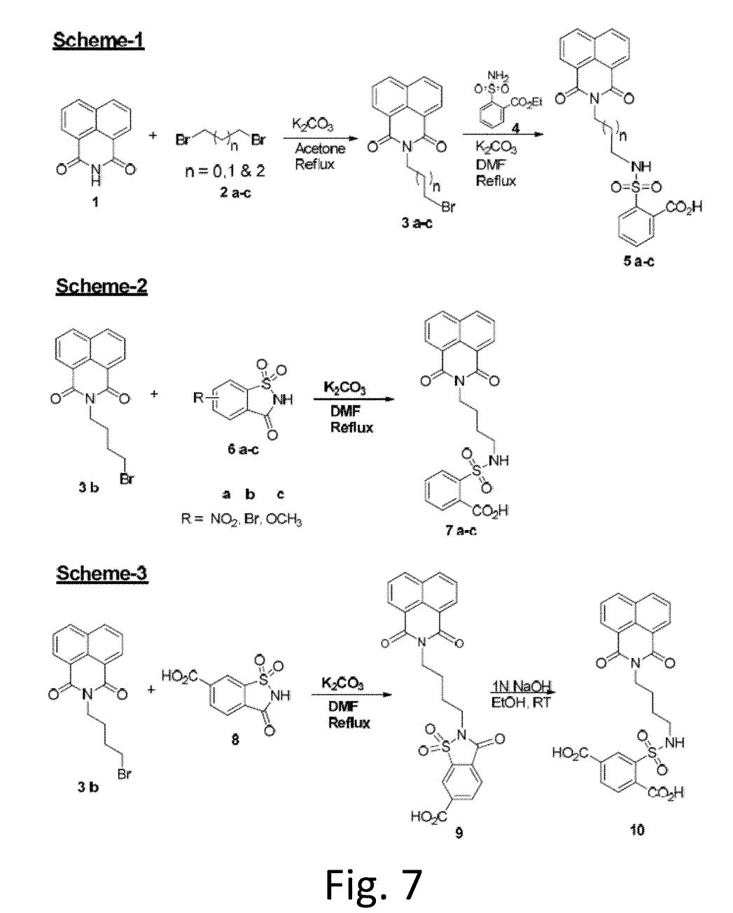

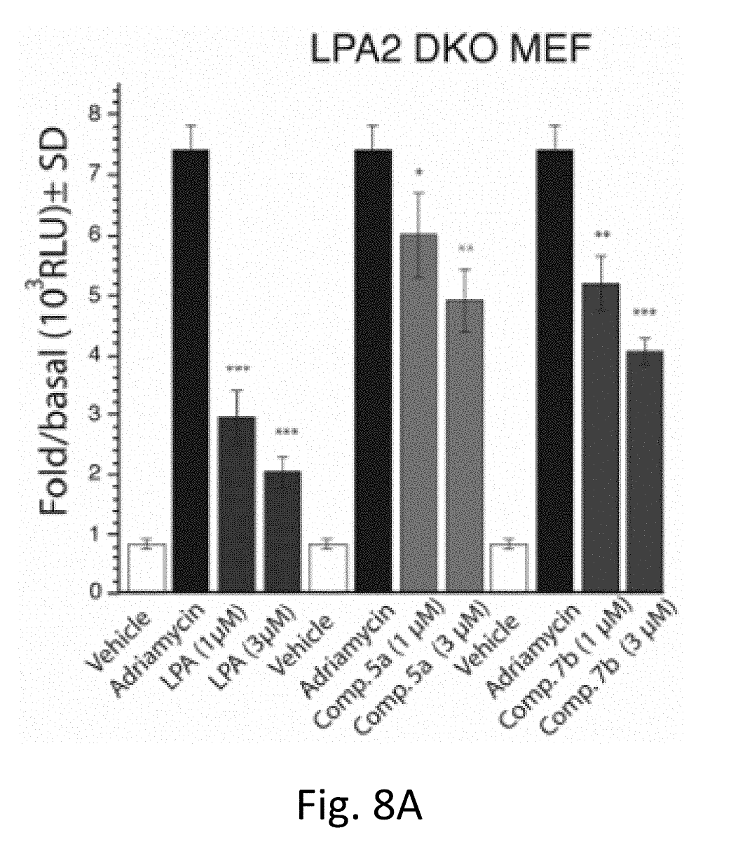

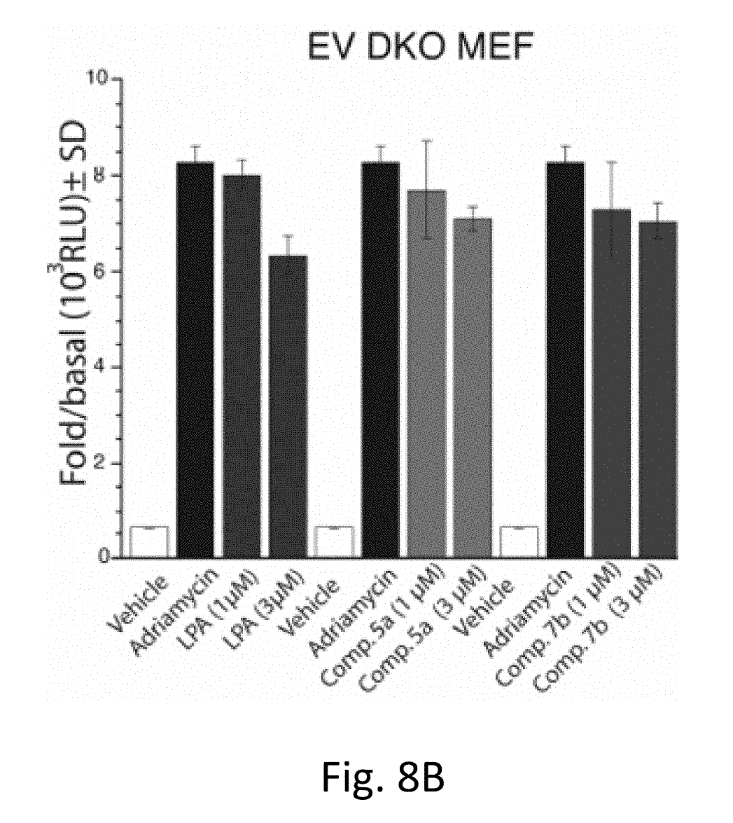

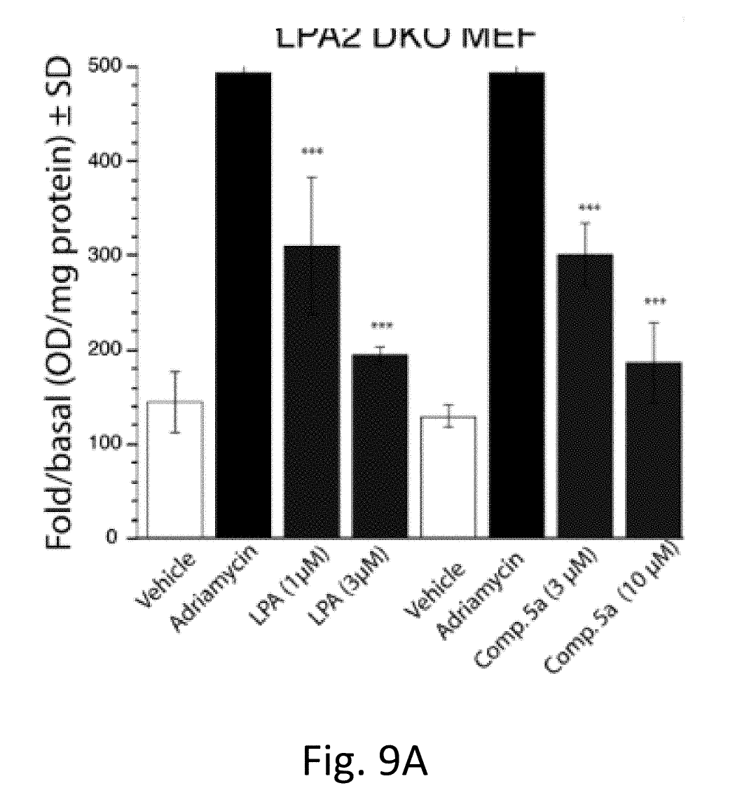

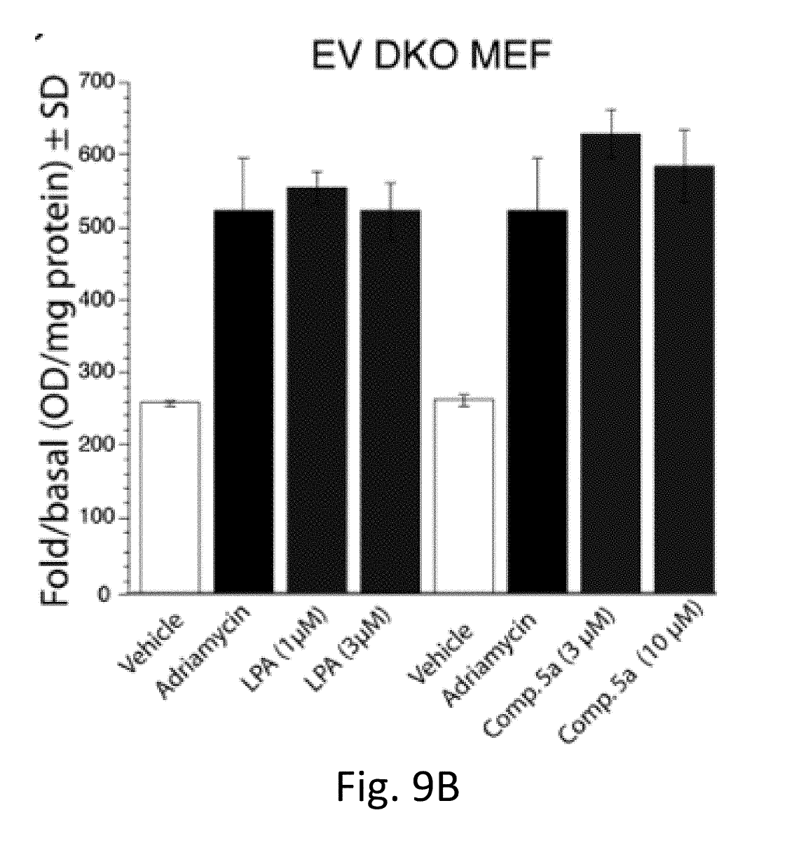

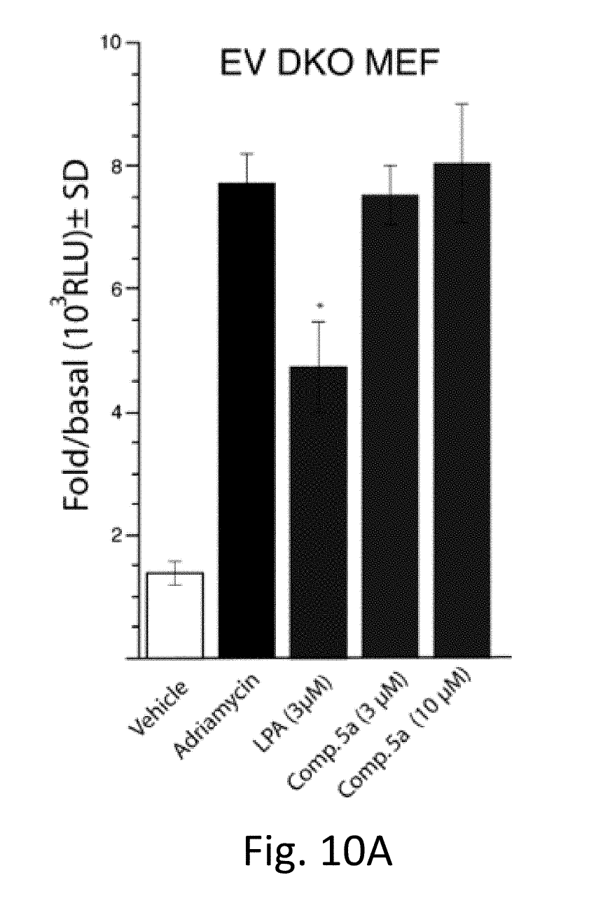

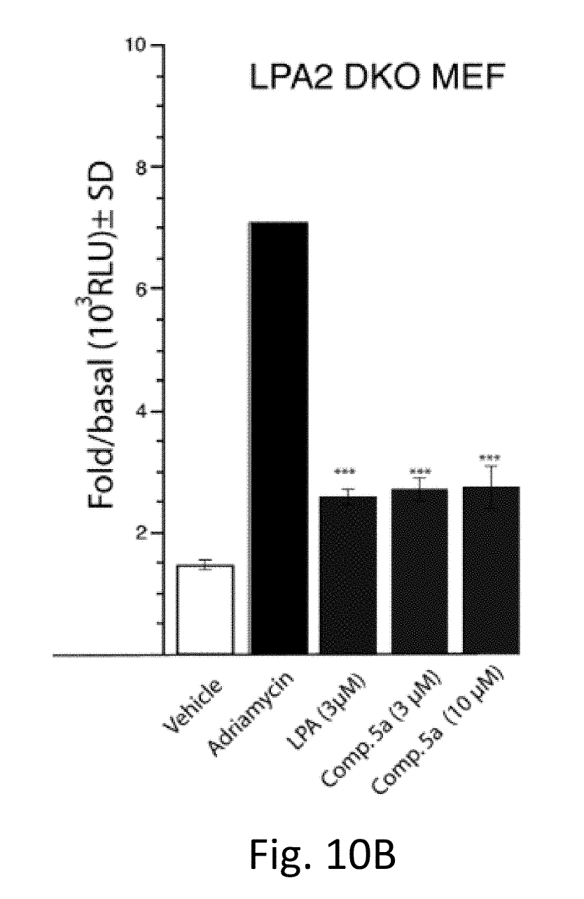

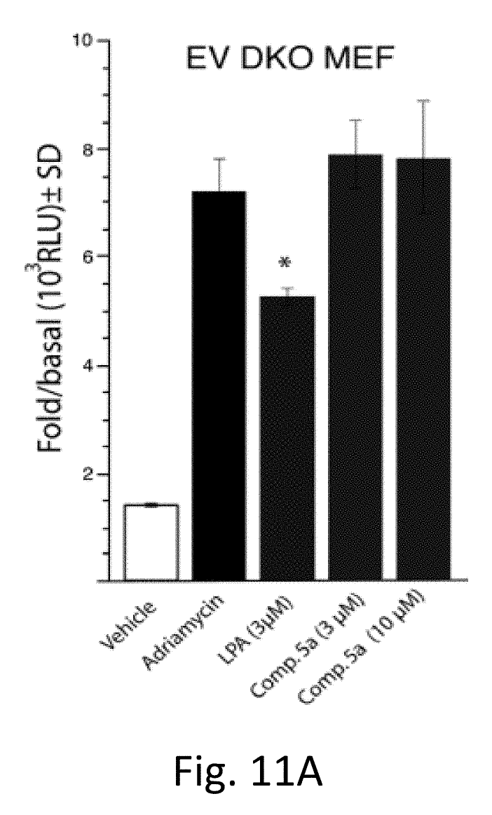

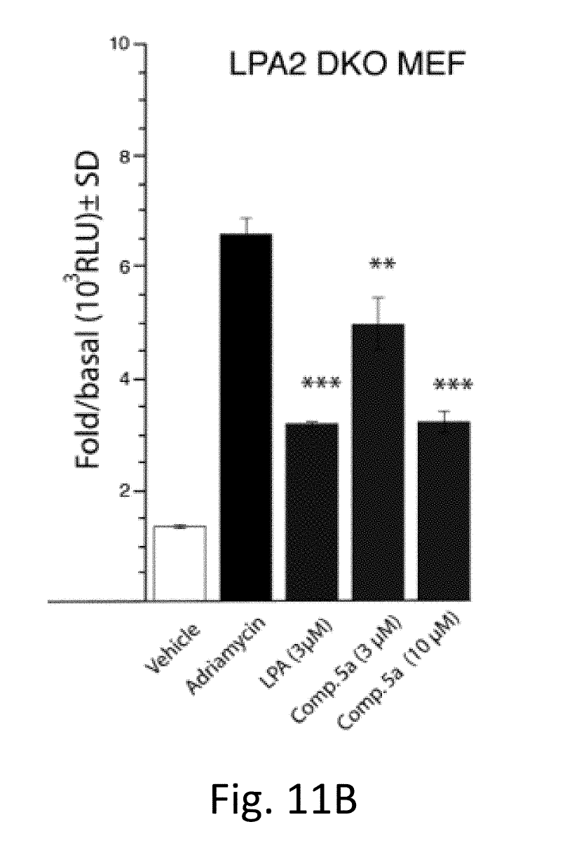

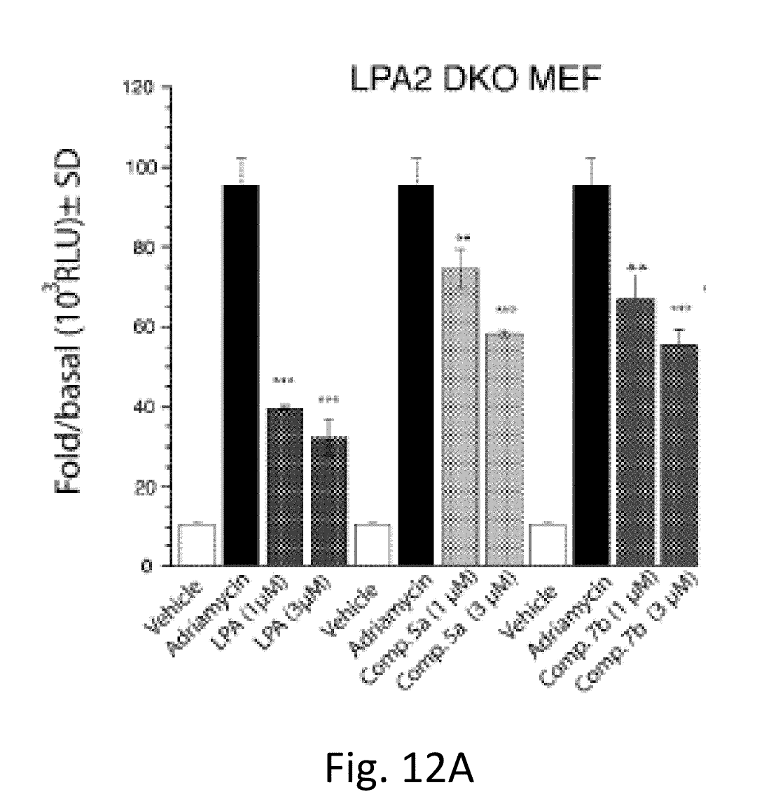

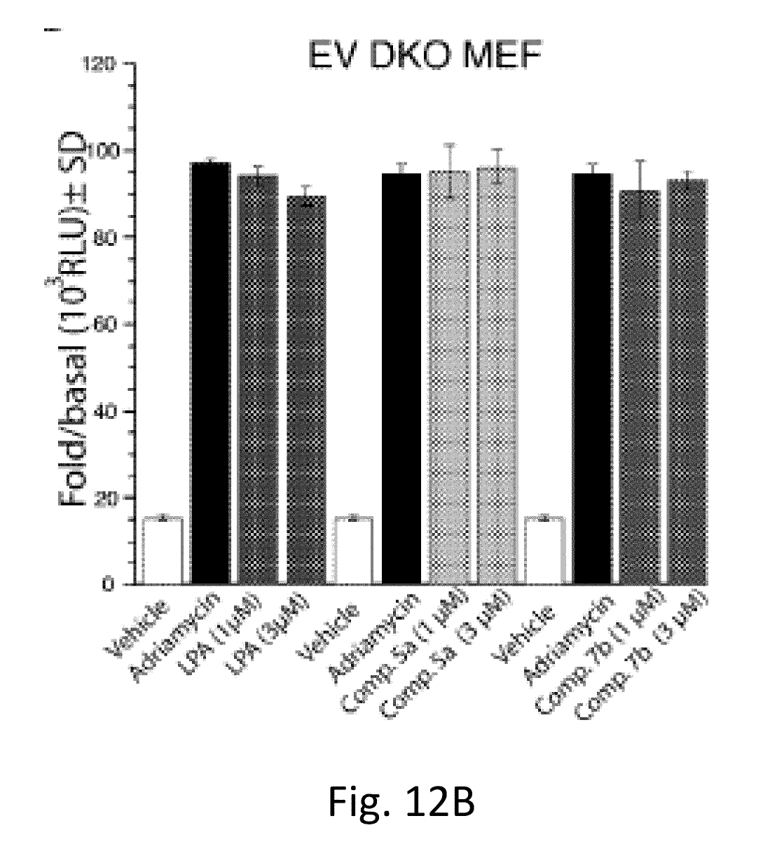

Another three-dimensional pharmacophore model for LPA₂ receptor agonist activity was constructed using the molecular modeling software Autodock Vina and the MOE software. See FIGS. 4C, 4E, 4D and 4F for four illustrations of the geometry of the pharmacophore. Here RP-239 (one of our proprietary agonist compounds to the LPA₂ receptor) was docked into a homology model of LPA₂ receptor using Autodock Vina (two illustrations shown in FIGS. 4A-B). The lowest energy pose of the docking results was selected for pharmacophore generation. The pharmacophore model was constructed by flexibly aligning LPA to a fixed position of RP-239 using the MOE software. The pharmacophore function of MOE was then used to map the consensus pharmacophore features of the best-fit aligned compounds. The pharmacophore is characterized by five features: A-Anionic, B-acceptor, C-Aromatic/Hydrophobic, D-hydrophobic, and E-Aromatic/Hydrophobic with the C-Aromatic/Hydrophobic, the B-Acceptor, and the D-hydrophobic reside geometrically between the A-Anionic and the E-Aromatic/Hydrophobic. Distances between each feature are measured in Å and shown in Table 3. The pharmacophore may be used for identifying an agonist of LPA₂ receptor. For example, one may design a candidate agonist according to the pharmacophore model of LPA₂ having features shown in Table 3 and then perform an assay by contacting the candidate agonist with LPA₂ to determine the ability of the agonist in binding to or regulating LPA₂ activity similar to the assay as described below with the compound GRI977143.

TABLE 3
Distances between the five features of the pharmacophore.

| | | | C- | | E- |
|---|---|---|---|---|---|
| | | | Aromatic/ | D- | Aromatic/ |
| | A- | B- | Hydro- | Hydro- | Hydro- |
| | Anionic | Acceptor | phobic | phobic | phobic |
| A-Anionic | | 3.2-6 | 3.7-5.5 | 7.4-10.2 | 6.4-13.4 |
| B-Acceptor | 3.2-6 | | 3.3-5.3 | 4.3-6.3 | 7.9-9.9 |
| C-Aromatic/ | 3.7-5.5 | 3.3-5.3 | | 6.2-8.2 | 8.9-10.9 |
| Hydrophobic | | | | | |
| D-Hydrophobic | 7.4-10.2 | 4.3-6.3 | 6.2-8.2 | | 5.9-8.6 |
| E-Aromatic/ | 6.4-13.4 | 7.9-9.9 | 8.9-10.9 | 5.9-8.6 | |
| Hydrophobic | | | | | |

### Cell Culture

Mouse embryonic fibroblast (MEF) cells used in this study isolated from LPA1/2 double knock out (LPA₂-DKO) mice {Lin, 2007 #132}. These MEF express LPA4/5/6 receptors endogenously at lower levels but completely lack LPA1/2/3 receptor subtypes. The human LPA₂ receptor was reintroduced into these MEF cells by lentiviral transduction, which are designated LPA₂ DKO MEF {Lin, 2007 #132}. Empty vector-transduced MEF cells, designates as EV DKO MEF, were used as a control. Cells were cultured in a DMEM supplemented with 10% v/v fetal bovine serum (FBS). 2 mM L-glutamine, 100 U/ml penicillin, and 100 μg/mL streptomycin. During serum starvation, the growth medium was replaced with DMEM containing 0.1% (w/v) BSA.

### Induction of Apoptosis by Adriamycin

The cells were plated in 48 well plates (2×10⁴ cells/well) and cultured overnight in full growth medium. Next morning the growth medium was replaced by serum-free starvation medium and cells were pretreated for 1 hour with LPA (1 or 3 μM), compound 5b or 7b (1, 3 or 10 μM). Apoptosis was elicited by 1.7 μM Adriamycin in vector and LPA₂ transduced MEF cells. Caspase 3, 7, 8, 9 activity and DNA fragmentation were measured to assess apoptosis 5 h after Adriamycin exposure.

Induction of Apoptosis by Direct γ-irradiation

MEF cells were plated the day before the irradiation in 48 well plates at a density of 2×10⁴ cell/well. One hour before the irradiation the growth medium was changed to serum-free starvation medium and the cell cultures were exposed to a dose of 1.5 Gy y-irradiation, at a dose rate of 3.2 Gy/min. One hour post irradiation cells were treated with either vehicle (BSA or DMSO), LPA (1-3 μM), compound 5b, or compound 7b both at 1.3 or 10 μM. Caspase activation, DNA fragmentation were measured 4 h after the irradiation.

### Caspase Activation Assay

To measure caspase activation the cells were lysed in 50 μl Caspase-Glow® reagent (Caspase 3/7, 8, 9 Promega, Madison, Wis.). The cells were shaken with the caspase reagent for 30 min at room temperature (RT). After 30 min, the luminescence was measured using a BioTek (Winooski, Vt.) plate reader. The mean caspase activity in triplicates/experimental group±SD was calculated. LPA was used as a positive control in all experiments.

### DNA Fragmentation ELISA

DNA fragmentation was quantified by using the Cell Death Detection ELISA assay kit (Roche Diagnostics, Penzberg, Germany). 20 μl cell lysate was incubated with the anti-histone biotin anti-DNA-peroxidase-conjugated antibody in a 96-well steptavidin-coated plate with shaking at RT for 2 h. After washing the wells three-times with the incubation buffer, 100 μl/well 2,2′-azino-di(3-ethylbenzthiazolin-sulfonate) substrate was added and the absorbance was measured at 405 nm. Protein concentration was measured using BCA Protein Assay Kit (Thermo Fishes Scientific Inc., Rockford, Ill.) DNA fragmentation was expressed as absorbance units/mg protein. LPA was used as a positive control in all experiments.

Effect of GRI Analogs on Radiation-induced Mortality in C57BL/6 Mice Exposed to 15.68 Gy Partial Body Irradiation with 5% Bone Marrow Shielding (PBI-BM5)

10-week old female C57BL/6 mice were exposed to a 15.68 Gy (˜LD_{60/8-10}) dose of γ-irradiation from a ¹³⁷Cs Source. Twenty four hours after irradiation mice were treated with a single 200 μL subcutaneous injection of 1 mg/kg of the test compounds 5b, 7a, and 7b dissolved in 0.8% DMSO, 1% ethanol. 2% propanediol in PBS buffer. The animals were observed daily and provided with food and water ad libitum. From day four onward the mice also were provided with a gel food diet. The study endpoint was mortality by day 20. Results are shown in FIG. 20. Notably, compounds 5a and 7a significantly reduced mortality (p<0.001), whereas compound 7b in this dosing and formulation was ineffective.

### Fura-2AM Ca2+ Assay for Agonism of RP-10-71 and RP-10-73

To determine the EC50 values of RP-10-71 and RP-10-73 compared to LPA18:1 in Ca2 mobilization, triplicate wells of Fura-2AM-loaded LPA₂ DKO MEF cells were treated with 0.0003-0.1 μM LPA18:1 or 0.003-3 μM RP compounds in the presence of equimolar BSA in Krebs buffer. Fluorescence was read every 3.42 seconds for a total of 70 seconds at Ex/Emγ of 340/510 nm and 380/510 nm. Data (relative fluorescence) was then recorded as a mean fluorescence ratio value of the triplicates for each concentration. GraphPad Prism version 5.0a was then used to fit a non-linear regression curve in a variable slope model (A) to determine the EC50, Emax, and curve fit (R²) (B). Results are shown in Table 3.

TABLE 4
LPA₂ Ca²⁺ Mobilization in DKO MEF Cells: Pharmacodynamics

| | EC₅₀(nM) | Eₘₐₓ(MFR) | Fit(R²) |
|---|---|---|---|
| LPA 18:1 | 7.4 | 1.2 | 0.99 |
| RP-10-71 | N/A | N/A | 0.67 |
| RP-10-73 | 6.0 | 1.2 | 0.96 |

1-15. (canceled)

16. A method for identifying a candidate agonist specific to LPA₂ receptor, comprising:
a. providing a pharmacophore model of a LPA₂ ligand, wherein the pharmacophore model contains five chemical features: A—Anionic, B—Acceptor, C—Aromatic/Hydrophobic, D—hydrophobic, and E—Aromatic/Hydrophobic with the C—Aromatic/Hydrophobic, the B—Acceptor, and the D—hydrophobic reside geometrically between the A—Anionic and the E—Aromatic/Hydrophobic; and wherein the distances in Å between the five chemical features are shown in the chart below:

| | | | C- | | E- |
|---|---|---|---|---|---|
| | | | Aromatic/ | D- | Aromatic/ |
| | A- | B- | Hydro- | Hydro- | Hydro- |
| | Anionic | Acceptor | phobic | phobic | phobic |
| A-Anionic | | 3.2-6 | 3.7-5.5 | 7.4-10.2 | 6.4-13.4 |
| B-Acceptor | 3.2-6 | | 3.3-5.3 | 4.3-6.3 | 7.9-9.9 |
| C-Aromatic/ | 3.7-5.5 | 3.3-5.3 | | 6.2-8.2 | 8.9-10.9 |
| Hydrophobic | | | | | |
| D-Hydrophobic | 7.4-10.2 | 4.3-6.3 | 6.2-8.2 | | 5.9-8.6 |
| E-Aromatic/ | 6.4-13.4 | 7.9-9.9 | 8.9-10.9 | 5.9-8.6 | |
| Hydrophobic; | | | | | |

b. contacting the candidate agonist with LPA₂ to determine whether the candidate agonist binds to or regulates LPA₂ activity; and
c. selecting the candidate agonist that binds to or regulates LPA₂ activity, but does not bind to or regulate activity of any other known LPA receptor.

17. The method of claim 16, wherein the candidate agonist so identified is of Formula I
wherein A is 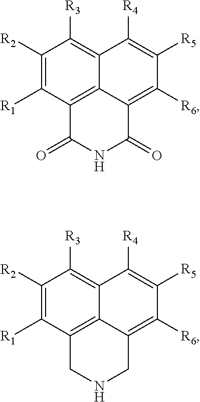 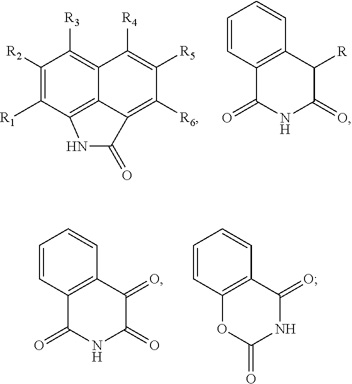
R is H or substituted or unsubstituted phenyl;
R₁, R₂, R₃, R₄, R₅, and R₆ are independently H, NO₂, Br, Cl, or OCH₃;
B is C₂ to C₈ alkyl or alkenyl; and
C is 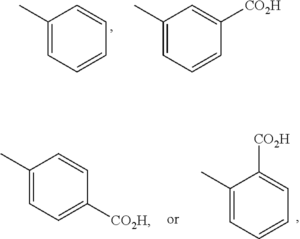
optionally substituted with F, Cl, Br, NO₂, NH₂, OCH₃, CH₃, CO₂H, or phenyl.

18. The method of claim 17, wherein A is

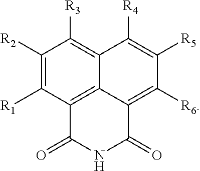

19. The methods of claim 17 wherein C is [chemical structure]
